(19) United States
(12) Patent Application Publication
(10) Pub. No.: US 2011/0158212 A1
(43) Pub. Date: Jun. 30, 2011

(54) COMMUNICATION DEVICE AND WIRELESS COMMUNICATION CONNECTION METHOD

(75) Inventors: Masaki SAKAI, Tokyo (JP); Takashi Minemura, Tokyo (JP); Kengo Kurose, Tokyo (JP); Kentaro Nagahama, Tokyo (JP)

(73) Assignee: KABUSHIKI KAISHA TOSHIBA, Tokyo (JP)

(21) Appl. No.: 12/876,504

(22) Filed: Sep. 7, 2010

(30) Foreign Application Priority Data
Dec. 28, 2009 (JP) P2009-298798
Mar. 12, 2010 (JP) P2010-056678

(51) Int. Cl. H04W 4/00; H04B 7/005

(52) U.S. Cl. 370/338; 455/509

(57) ABSTRACT

According to an embodiment, a communication terminal includes a wireless communication unit, a radio signal detection unit, and a control unit. The wireless communication unit performs a wireless communication process with other terminal that transmits a radio signals for requesting the wireless communication between terminals. The radio signal detection unit waits for the radio signals with lower operating power than operating power when the wireless communication unit waits for the radio signals. The control unit activates the wireless communication unit to cause the wireless communication unit to perform a connection process of the wireless communication when the radio signal detection unit detects the radio signal.

### CROSS-REFERENCE TO RELATED APPLICATION

This application is based upon and claims the benefit of priority from Japanese Patent Application No, 2009-298798, filed Dec. 28, 2009; and No, 2010-056678, filed Mar. 12, 2010; the entire contents of all of which are incorporated herein by reference.

### FIELD

Embodiments describe herein relate generally to a communication device and a wireless communication connection method.

### BACKGROUND

Nowadays, communication devices have various forms, and more users own a plurality of communication devices. Examples of the various types of communication devices include cell phones, notebook personal computers, desktop personal computers, and gaming devices and music players. Various performances, such as the size of a screen or a keyboard, and the capability of a CPU, of the communication devices are different, and the communication devices each have suitable situations for using.

There is a known technique of forming a local network by wireless communication using a communication system, such as wireless LAN and Bluetooth, between the communication devices. These devices execute a synchronous process of data between the devices or cause one of the devices to function as a modem to connect the other devices to a common carrier network.

Conventionally, there is known a communication system in which two or more devices (for example, a cell phone terminal and a personal computer) form a local network to perform mutual data communication (for example, see JP2001-103568A). The communication system disclosed in JP2001-103568A is a system that allows remotely operates software installed in one of the devices and thereby displays, on the other device, display data generated by the software. In the communication system, a personal computer in a link request standby state periodically monitors whether an establishment request of a wireless link is transmitted from a cell phone terminal. If there is a link establishment request, the personal computer confirms that the partner is the cell phone terminal from ID information included in the link establishment request. After the confirmation, the personal computer controls a baseband unit for establishing the wireless link with the cell phone terminal using 2.4 GHz wireless communication device to link with a 2.4 GHz wireless communication device of the cell phone terminal.

For communicating between a plurality of terminals by the wireless, a wireless communication module, such as a wireless LAN communication module, needs to periodically or always monitor the connection establishment request from the terminal of the partner. However, the terminal needs to consume power for periodical monitoring, which is a factor for reducing the continuous drive time of the terminal. For example, if the communication device is a terminal such as a cell phone, the power consumption for monitoring the connection establishment request is by several milliamperes. The power consumption is comparable to power consumption during normal standby in which the connection establishment request is not monitored. Thus, the consecutive standby time for one time battery charge is reduced.

A method of activating both communication modules only when a communication is required may be thought effective to remarkably reduce the power consumption during monitoring of the connection establishment request. However, the operation of activating the communication module for the communication is cumbersome for the user.

JP2001-103568A discloses only a technique of allowing one terminal to periodically monitor whether an establishment request of wireless link being transmitted from the other terminal. JP2001-103568A doesn't disclose any countermeasures for the problems are not taken at all.

### BRIEF DESCRIPTION OF THE DRAWINGS

In the accompanying drawings:

FIG. 1 is a conceptual diagram for explaining a network formed between communication devices according to a present embodiment;

FIG. 2 is a hardware system block diagram of a cell phone as a communication device on a host side in the present embodiment;

FIG. 3 is a circuit block diagram of a radio signal detection circuit of FIG. 2;

FIG. 4 is a detailed block diagram of a signal identification circuit and a control signal output circuit of FIG. 3;

FIG. 5 is a diagram showing a specific pattern of a signal detected by a WLAN signal detection circuit;

FIG. 6 is a diagram showing a specific pattern of a signal detected by a BT signal detection circuit;

FIG. 7 is a software system block diagram of the cell phone as a communication device in the present embodiment;

FIGS. 8A and 8B are diagrams showing an example of a UW table;

FIG. 9 is a hardware system block diagram of a PC as a communication device in the present embodiment;

FIG. 10 is a software system block diagram of the PC as a communication device in the present embodiment;

FIG. 11 is a diagram for explaining combinations of operation modes that can be taken by WLAN communication modules and of the cell phone and the PC;

FIG. 12 is a flow chart for explaining a connection process using a first communication method executed in the cell phone of the present embodiment;

FIG. 13 is a sequence diagram showing a connection process using the first communication method executed between the cell phone and the PC;

FIG. 14 is a sequence diagram showing a process following FIG. 13;

FIG. 15 is a sequence diagram showing a process following FIG. 14;

FIG. 16 is a sequence diagram showing a process following FIG. 15;

FIG. 17 is a flow chart for explaining a connection process by the first communication method during a terminal mode operation executed in the PC of the present embodiment;

FIG. 18 is a flow chart for explaining a connection process by the first communication method during an AP mode operation executed in the PC of the present embodiment;

FIG. 19 is a flow chart for explaining a connection process using a second communication method executed in the cell phone of the present embodiment;

FIG. 20 is a sequence diagram showing a process using the second communication method executed between the cell phone and the PC;

FIG. 21 is a sequence diagram showing a process following FIG. 20;

FIG. 22 is a flow chart for explaining a connection process by the second communication method during an ad hoc mode operation executed in the PC of the present embodiment;

FIG. 23 is a flow chart for explaining a connection process using a third communication method executed in the cell phone of the present embodiment;

FIG. 24 is a sequence diagram showing a process using the third communication method executed between the cell phone and the PC;

FIG. 25 is a sequence diagram showing a process following FIG. 24;

FIG. 26 is a sequence diagram showing a process following FIG. 25;

FIG. 27 is a flow chart for explaining a connection process by the third communication method during a BT mode operation executed in the PC of the present embodiment;

FIG. 28 is a flow chart for explaining a synchronous process by Bluetooth communication executed by the cell phone of the present embodiment;

FIG. 29 is a sequence diagram showing a synchronous process between the cell phone and the PC by Bluetooth communication;

FIG. 30 is a flow chart for explaining a synchronous process executed by controlling by an application using Bluetooth communication executed by the PC of the present embodiment;

FIG. 31 is a flow chart for explaining a synchronous process executed based on a starting instruction of the user using Bluetooth communication executed by the PC of the present embodiment;

FIG. 32 is a flow chart for explaining a UW registration process executed by the cell phone of the present embodiment;

FIG. 33 is a flow chart for explaining a UW registration process corresponding to the UW registration process of FIG. 32 executed by the PC of the present embodiment;

FIG. 34 is a flow chart for explaining another UW registration process executed by the cell phone of the present embodiment;

FIG. 35 is a flow chart for explaining a UW registration process corresponding to the UW registration process of FIG. 34 executed in the PC of the present embodiment;

FIG. 36 is a flow chart for explaining a wireless LAN communication process based on detection of a UW signal executed by the cell phone of the present embodiment;

FIG. 37 is a sequence diagram showing a wireless LAN communication process based on detection of a UW signal between the cell phone and the PC;

FIG. 38 is a flow chart for explaining a wireless LAN communication process based on detection of a UW signal executed by the PC of the present embodiment;

FIG. 39 is a flow chart for explaining a synchronous process by Bluetooth communication based on detection of a UW signal executed by the cell phone of the present embodiment;

FIG. 40 is a sequence diagram showing a synchronous process between the cell phone and the PC using Bluetooth communication;

FIG. 41 is a flow chart for explaining a synchronous process that uses Bluetooth communication based on detection of a UW signal executed by the PC and that is executed by an application according to the present embodiment;

FIG. 42 is a flow chart for explaining a synchronous process that is a process using Bluetooth communication based on detection of a UW signal executed by PC and that is executed based on a starting instruction of the user according to the present embodiment;

FIG. 43 is a diagram for explaining a UW registration process executed at application initial activation in the cell phone of the present embodiment;

FIG. 44 is a diagram showing a table in which UW is allocated to each business;

FIG. 45 is a hardware system block diagram as a modified example of the PC of the present embodiment; and

FIG. 46 is a software system block diagram as a modified example of the PC of the present embodiment.

### DETAILED DESCRIPTION

An Embodiment of a present invention has an object to provide a communication device and a wireless communication connection method on a host side that suitably reduce power consumption in monitoring a connection establishment request of communication between terminals and a communication device on a client side that requests the communication device for connection.

To solve the problems, a communication device of the present embodiment provides a wireless communication unit, a radio signal detection unit, and a control unit. The wireless communication unit performs a wireless communication process with other terminal that transmits a radio signals for requesting the wireless communication between terminals. The radio signal detection unit waits for the radio signals with lower operating power than operating power when the wireless communication unit waits for the radio signals. The control unit activates the wireless communication unit to cause the wireless communication unit to perform a connection process of the wireless communication when the radio signal detection unit detects the radio signals.

An embodiment of communication devices and a wireless communication connection method according to the present invention will be described based on the attached drawings.

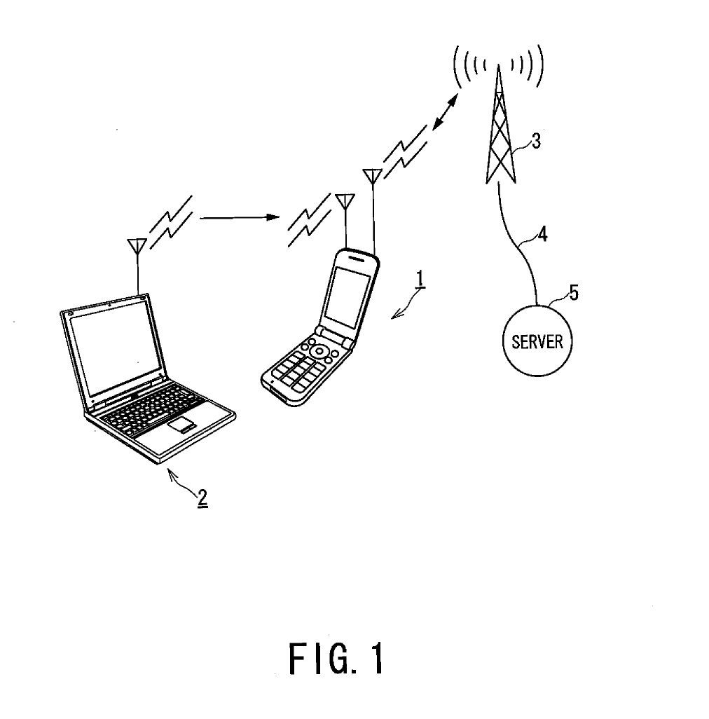

FIG. 1 is a conceptual diagram for explaining a network formed between communication devices according to the present embodiment.

The present embodiment applies an example of data communication by a notebook personal computer (hereinafter referred to as “PC”) 2 using a mobile communication network of a cell phone 1 as a relay station. In the following paragraph, system configurations thereof and functions of each part will be described below.

Although the cell phone 1 and the PC 2 are applied as the communication devices, the cell phone 1 may perform data communication using a communication network of the PC 2, or communication devices other than the cell phone 1 and the PC 2 may be applied. For example, various communication devices with communication functions, such as a PDA (Personal Digital Assistant), a portable gaming device, a portable music player, and a portable video player, can be applied.

The cell phone 1 uses a communication system, such as a W-CDMA system, to transmit and receive sound and data to and from a base station 3 in the mobile communication network: The base station 3 is connected to a predetermined server 5 through a predetermined public line network 4. The cell phone 1 is a communication device that communicates with a communication unit, such as wireless LAN (Local Area Network) and Bluetooth, to wirelessly communicate with other terminals including the PC 2.

The PC 2 is a communication device that communicates with a communication unit, such as wireless LAN and Bluetooth, to wirelessly communicate with other terminals including the cell phone 1.

The cell phone 1 and the PC 2 form a local network by wireless LAN, Bluetooth, etc. utilizing a communication system different from that in the wireless communication between the cell phone 1 and the base station 3 to transmit and receive data each other. The cell phone 1 and the PC 2 may realize the wireless communication at a distance of several meters in consideration of the power consumption.

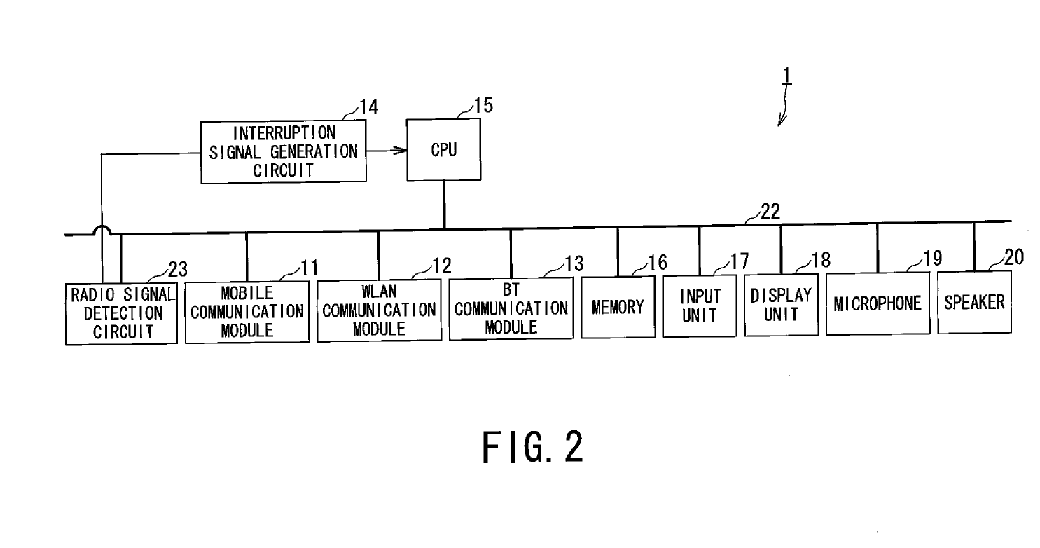

FIG. 2 is a hardware system block diagram of the cell phone 1 as a communication device on the host side in the present embodiment.

A configuration for realizing wireless communication with the PC 2 as one of the other communication devices will be mainly described for the cell phone 1 in the present embodiment, and details of a hardware system configuration generally included in cell phones will not be described.

The cell phone 1 comprises a mobile communication module 11, a wireless LAN (WLAN) communication module 12, a Bluetooth (BT) communication module 13, a CPU 15, a memory 16, an input unit 17, a display unit 18, a microphone 19, a speaker 20, and a radio signal detection circuit 23. The components of the cell phone 1 are connected through a bus 22.

The mobile communication module 11 transmits and receives of sound and data to and from the base station 3 (see FIG. 1). The mobile communication module 11 comprises an antenna and receives radio signals through the space transmitted by a predetermined communication processing system from the base station 3 in the mobile communication network. The mobile communication module 11 also emits a predetermined radio signals to the space through the antenna toward the base station 3 to allow wireless communication by a predetermined communication processing system. The mobile communication module 11 performs predetermined processing to the received signals and then outputs data to the CPU 15 or outputs sound from the speaker 20. The mobile communication module 11 also executes predetermined processing to data outputted by the CPU 15 and sound collected by the microphone 19 and then transmits them.

The wireless LAN (WLAN) communication module 12 performs wireless LAN communication compliant with a predetermined standard, such as IEEE 802.11a/b/g, through the antenna.

The Bluetooth (BT) communication module 13 wirelessly communicates with other communication devices existing in proximity (e.g., several to ten-odd meters) to the cell phone 1 through the antenna.

The cell, phone 1 may comprise only the WLAN communication module 12 to execute processes by wireless LAN communication described later. The cell phone 1 may comprise only the BT communication module 13 to execute processes by Bluetooth communication describe later. The same applies to the PC 2.

The CPU (Central Processing Unit) 15 generates and supplies various control signals to control the components of the cell phone 1. The CPU 15 executes various processes according to programs stored in a ROM (Read Only Memory) or various application programs or control programs including an operating system (OS) loaded from the ROM to a RAM (Random Access Memory).

The memory 16 is a storage device such as a ROM, a RAM, a flash memory device, and an HDD (Hard Disc Drive).

The input unit 17 receives input through, for example, an operation key-type input unit or a touch panel-type input unit and transfers the input signal to the CPU 15. The display unit 18 displays data including characters or images under the control of the CPU 15. The display unit 18 is constituted by, for example, an LCD (Liquid Crystal Display), an organic EL (ElectroLuminescence) display, and an inorganic EL display.

The radio signal detection circuit 23 is a circuit for detecting an amplitude-modulated (on-off keying) radio signals. The radio signal detection circuit 23 determines the type of the radio signals based on a signal pattern of the radio signals received from other communication devices, such as an access point (hereinafter referred to as “AP”) and a personal computer (PC). The signal pattern is judged based on a period between successive signals and a level of each signal detected along the time axis. Hereinafter, the signal pattern will be called a “specific pattern'”.

The radio signal detection circuit 23 outputs a predetermined interruption signal to the interruption signal generation circuit 14 if the specific pattern corresponds with a specific pattern of a waiting radio signal stored in advance. The interruption signal generation circuit 14 generates an interruption signal based on the signal outputted by the radio signal detection circuit 23 and notifies the CPU 15 of the generation of an interruption process.

The WLAN communication module 12 and the BT communication module 13 have functions of obtaining data by down-converting and decoding the received radio signals and functions of transmitting data (encoding, modulating, and radio signal transmission). Therefore, the operating power of the WLAN and BT communication module are higher than that in the radio signal detection circuit 23. More specifically, the radio signal detection circuit 23 is capable of waiting for the predetermined radio signals by lower operating power than the operating power when the WLAN communication module 12 and the BT communication module 13 monitor the predetermined radio signals sent out from an AP or a PC. Therefore, instead of the WLAN communication module 12 and the BT communication module 13, the radio signal detection circuit 23 of the cell phone 1 in the present embodiment waits for the radio signal to reduce the power consumption of the whole system of the cell phone 1.

The circuits of the radio signal detection circuit 23 are constituted by applying conventional techniques capable of realizing power saving described in documents shown in the descriptions of the circuits. Additionally, the radio signal detection circuit 23 can have not only the configurations described in the documents described below, but can have any configurations as long as the radio signal can be at least monitored by lower operating power than the operating power when the WLAN communication module 12 and the BT communication module 13 monitor the radio signal sent out by the PC 2.

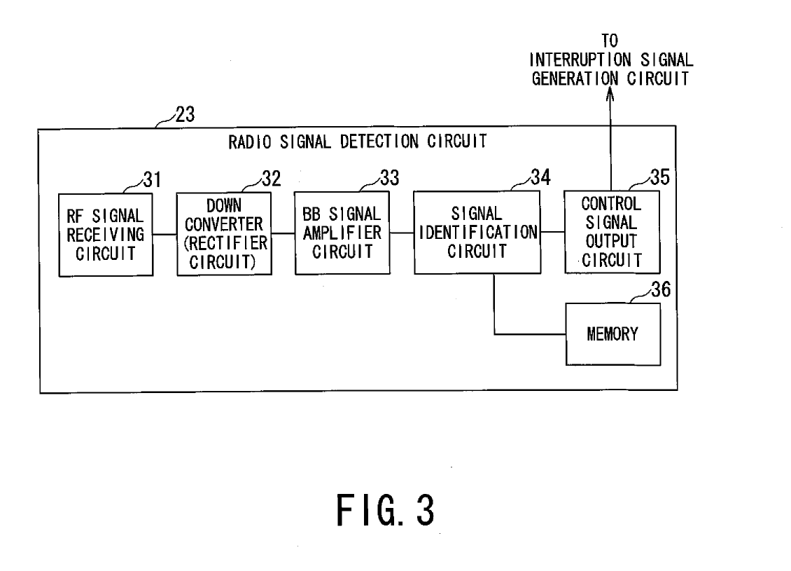

FIG. 3 is a circuit block diagram of the radio signal detection circuit 23 of FIG. 2.

The radio signal detection circuit 23 comprises an RF signal receiving circuit 31, a down converter (rectifier circuit) 32, a baseband (BB) signal amplifier circuit 33, a signal identification circuit 34, a control signal output circuit 35, and a memory 36. Among the components, the RF signal receiving circuit 31, the down converter 32, and the BB signal amplifier circuit 33 are constituted by analog circuits. The signal identification circuit 34 and the control signal output circuit 35 are constituted by digital circuits.

When a radio signal (radio wave) reaching a detection sensitivity sent out by another communication device, such as an AP and the PC 2, is received, the RF (Radio Frequency) signal receiving circuit 31 amplifies the signal and outputs the signal to the down converter 32.

The down converter (rectifier circuit) 32 rectifies and detects an RF signal outputted from the RF signal receiving circuit 31 to acquire a demodulation signal. The down converter (rectifier circuit) 32 does not include a local oscillator in order to save power. A technique described, for example, in JP4377946B (demodulation apparatus) can be applied to the configuration of the down converter 32.

The BB signal amplifier circuit 33 amplifies the demodulation signal outputted from the down converter 32. A technique described, for example, in JP2009-89434A (trigger signal generation apparatus) can be applied to the configuration of the BB signal amplifier circuit 33.

The signal identification circuit 34 compares the signal generated by the BB signal amplifier circuit 33 with a predetermined reference potential. Although a plurality of values can be set for the reference potential, it is preferable to set a lower threshold to allow detection of all signals including low level ones. The signal identification circuit 34 determines that a detected signal is at a high level if the signal has a potential equal to or higher than the reference potential. The signal identification circuit 34 determines that a detected signal is at a low level if the signal has a potential lower than the reference potential. The signal identification circuit 34 acquires a specific pattern based on these levels and a period of successive signals along the time axis.

Therefore, the signal identification circuit 34 acquires a specific pattern. The signal identification circuit 34 identifies whether the obtained signal corresponds to a specific pattern of a waiting radio signal and outputs the identification result to the control signal output circuit 35.

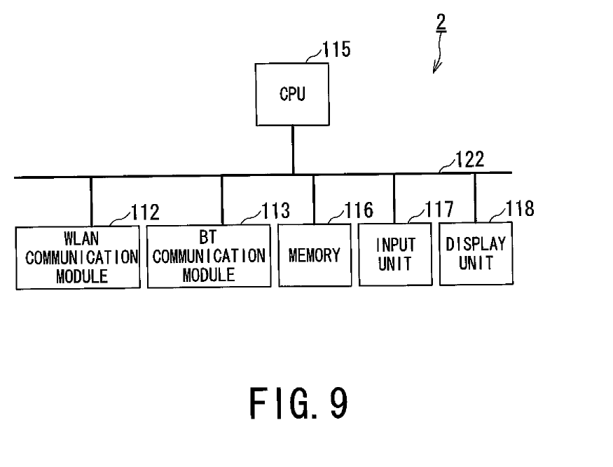

The memory 36 is, for example, a non-volatile memory and stores specific patterns of signals that the radio signal detection circuit 23 waits for. The memory 36 stores a plurality of specific patterns. Specifically, the memory 36 stores in advance specific patterns of signals (probe request signals) transmitted when a wireless LAN communication module 112 (see FIG. 9) of the PC 2 as the other terminal performs active scan. The memory 36 also stores in advance specific patterns of beacon signals transmitted by the wireless LAN communication module 112 (see FIG. 9) of the PC 2. The memory 36 further stores in advance specific patterns of signals (inquiry signals) transmitted when a Bluetooth communication module 113 (see FIG. 9) of the PC 2 performs inquiry scan.

In general, the probe request signals, the beacon signals, and the inquiry signals each have common specific patterns. The repetition periods of the signals patterns can be modified arbitrarily by the terminal settings for uniqueness. In addition to the general specific patterns which are fixed, this modification capability allows the memory 36 stores in advance specifically modified patterns of the signals transmitted from specific devices that perform particular connection.

The control signal output circuit 35 generates an interruption signal for notifying an occurrence of an interruption process based on the identification result outputted by the signal identification circuit 34 and outputs the interruption signal to the interruption signal generating circuit 14. The control signal output circuit 35 also executes a writing process to allow the CPU 15 to read the content of the interruption process as necessary.

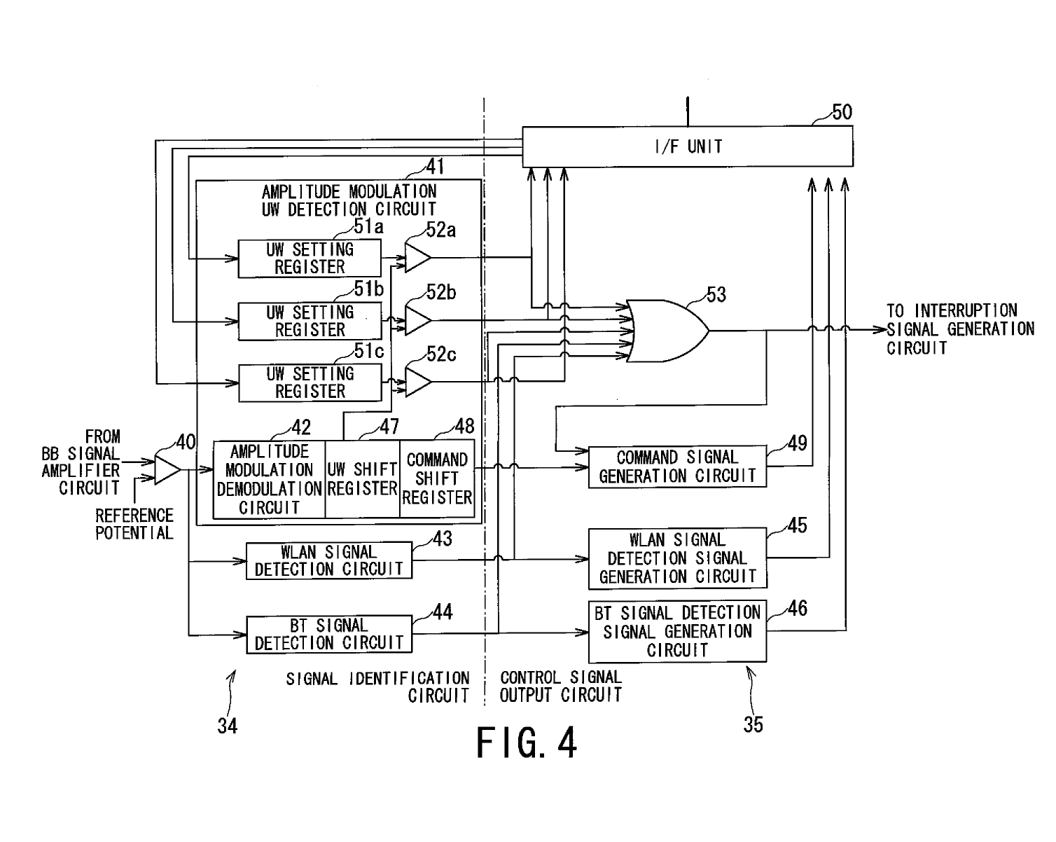

FIG. 4 is a detailed block diagram of the signal identification circuit 34 and the control signal output circuit 35 of FIG. 3.

The left side of the alternate long and short dash line in FIG. 4 denotes the signal identification circuit 34 of FIG. 3, and the right side of it denotes the control signal output circuit 35.

A comparator 40 of the signal identification circuit 34 compares the signal supplied from the BB signal amplifier circuit 33 and a reference potential. The comparator 40 determines that the signal is a high level if a signal higher than the reference potential is detected and determines that the signal is a low level if a signal lower than the reference potential is detected. The comparator 40 outputs the comparison result to an amplitude modulation demodulation circuit 42 of an amplitude modulation unique word (UW) detection circuit 41, a wireless LAN (WLAN) signal detection circuit 43, and a Bluetooth (BT) signal detection circuit 44.

The WLAN signal detection circuit 43 detects whether the obtained signal corresponds to a specific pattern of radio signals (hereinafter referred to as “WLAN signal”), such as beacon signals and probe request signals, sent out by the WLAN communication module 112 of the PC 2 (see FIG. 9). If the specific pattern of the waiting WLAN signal is detected, the WLAN signal detection circuit 43 notifies a WLAN signal detection signal generation circuit 45 of the control signal output circuit 35.

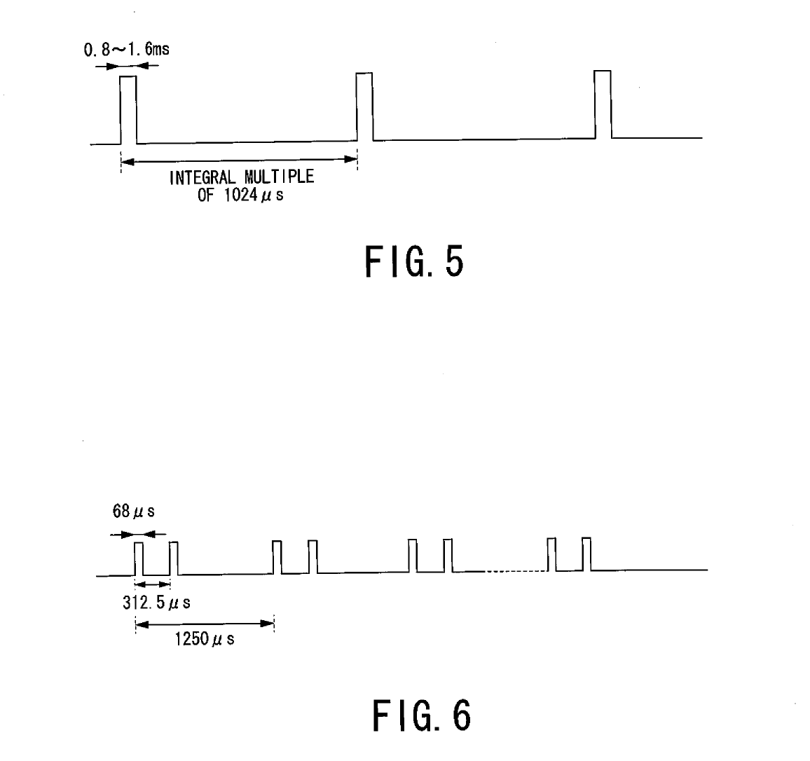

FIG. 5 is a diagram showing a specific pattern of a signal detected by the WLAN signal detection circuit 43.

The specific pattern of the signal detected by the WLAN signal detection circuit 43 is a pulse wave, in which, for example, the width of signal is 0.8 to 1.6 ms, and the signal period is an integral multiple (for example, 100 times) of 1024 μs.

The BT signal detection circuit 44 detects whether the obtained signal corresponds to a specific pattern of a signal (hereinafter referred to as “BT signal”) sent out by the BT communication module during inquiry scan. If the specific pattern of the waiting BT signal is detected, the BT signal detection circuit 44 notifies a Bluetooth (BT) signal detection signal generation circuit 46 of the control signal output circuit 35. The inquiry scan is a process of sending out a specific signal for searching another Bluetooth-compliant terminal and receiving a response signal from the compliant device.

FIG. 6 is a diagram showing a specific pattern of a signal detected by the BT signal detection circuit 44.

The specific pattern of the signal detected by the BT signal detection circuit 44 includes two pulse waves in which, for example, the width of signal is 68 μs, and the signal interval is 312.5 μs. The specific pattern is a pulse wave in which the signal period is 1250 μs.

The amplitude modulation demodulation circuit 42 of the amplitude modulation UW detection circuit 41 executes a process of demodulating the obtained signal. The demodulated signal is a signal (hereinafter referred to as “UW signal”) including a unique word (hereinafter referred to as “UW”) and a command sent out by the PC 2. The amplitude modulation demodulation circuit 42 executes the demodulation process to acquire the UW and the command.

The signal outputted by the amplitude modulation demodulation circuit 42 is supplied to a unique word (UW) shift register 47 and a command shift register 48. If the correspondence of the signals supplied to the UW shift register 47 with the UW set to at least one of UW setting registers 51 is detected, a command signal generation circuit 49 generates a command signal for the CPU 15 to read out through an interface (I/F) unit 50 in an interruption process.

Unique word (UW) setting registers 51a, 51b, and 51c (hereinafter referred to collectively as the UW setting registers 51 when there is no need to distinguish individual the UW setting registers) store the UW set by the CPU 15. Comparators 52a, 52b, and 52c (collectively, comparators 52) determine whether the signals supplied to the UW shift register 47 each correspond to the UW set to the UW setting registers 51. As a plurality of (three in the present embodiment) UW setting registers 51 and comparators 52 are prepared, the cell phone 1 can set the UW set with a plurality of communication terminals. Therefore, the cell phone 1 can simultaneously wait for connection request signals from different terminals.

A technique described, for example, in JP2009-33445A (receiving apparatus and method) can be applied as a specific configuration for supplying a signal to the UW shift register 47 and comparing the signal with the UW stored in the UW setting registers 51.

If the WLAN signal detection circuit 43 or the BT signal detection circuit 44 detects signals, or if the correspondence of the signals supplied to the UW shift register 47 with the UW set in at least one of the UW setting registers 51 is detected in the comparators 52, the an OR circuit 53 each receives notification. If the OR circuit 53 received the notification, the OR circuit 53 outputs the signal to the interruption signal generation circuit 14. The WLAN signal detection signal generation circuit 45, the BT signal detection signal generation circuit 46, and the comparators 52 each output, to the I/F unit 50, signals for the CPU 15 that has received the interruption signal to read.

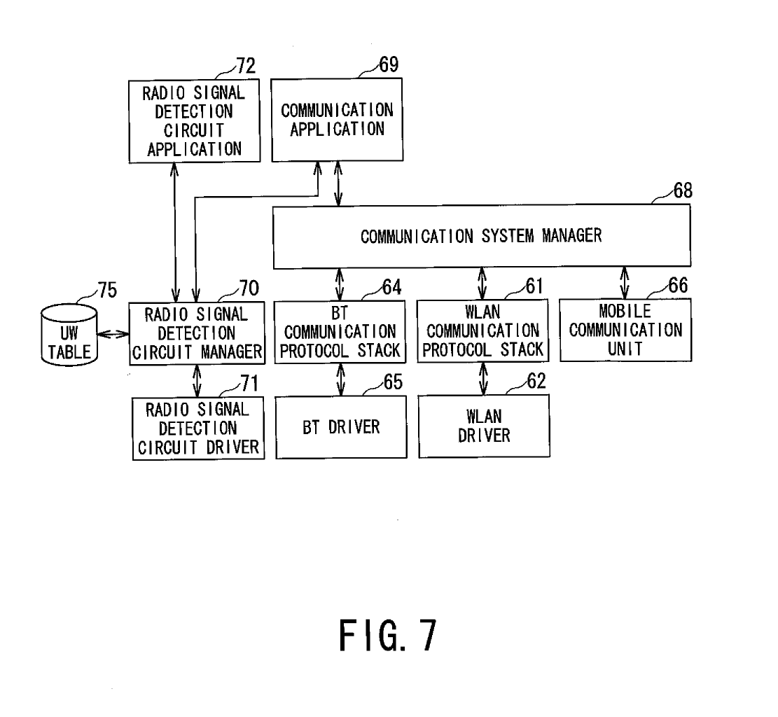

FIG. 7 is a software system block diagram of the cell phone 1 as a communication device in the present embodiment.

A configuration for realizing wireless communication with the PC 2 as one of the other communication devices will be mainly described for the cell phone 1 in the present embodiment, and details of a software system configuration generally included in cell phones will not be described.

A WLAN communication protocol stack 61 executes a predetermined WLAN communication procedure. A wireless LAN (WLAN) driver 62 controls the WLAN communication module 12 to perform the procedure executed by the WLAN communication protocol stack 61.

A Bluetooth (BT) communication protocol stack 64 executes a predetermined BT communication procedure. A Bluetooth (BT) driver 65 controls the BT communication module 13 to perform the procedure executed by the BT communication protocol stack 64.

A mobile communication unit 66 performs wireless communication by controlling the mobile communication module 11 during communication through a common carrier network of voice call, data communication, etc. of the cell phone 1.

A communication system manager 68 manages the WLAN communication protocol stack 61, the BT communication protocol stack 64, and the mobile communication unit 66. A communication application 69 directly receives, for example, a communication instruction from the user and notifies the communication system manager 68 of the instruction.

A radio signal detection circuit manager 70 comprehensively controls the radio signal detection circuit 23 and communicates with the applications. A radio signal detection circuit driver 71 operates the radio signal detection circuit 23 under the control of the radio signal detection circuit manager 70. A radio signal detection circuit application 72 receives, for example, an instruction and input data from the user and notifies the radio signal detection circuit manager 70 of the instruction and the input data.

A unique word (UW) table 75 stores at least one UW set by the user or at least one UW specific to applications.

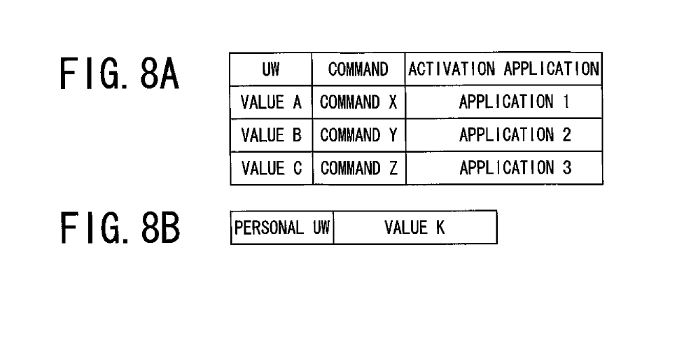

FIGS. 8A and 8B are diagrams showing an example of a UW table.

As shown in FIG. 8A, the UW table 75 stores the UW associated with command and application. The UW is identification information used to identify each of terminals requesting wireless communication. The commands indicate the content of the processes that are executed in the cell phone 1. The applications are applications allocated with activations based on the combinations of the UW and the commands. As shown in FIG. 8B, the UW table 75 also stores at least one personal UW generated by a radio signal detection circuit application. The personal UW is the UW being specific between terminals and optionally set by the user. Not only the UWs specific to the applications, but also any UW sets by the user can be used as the UW allocated to the activations of the applications. In that case, the personal UW stored in FIG. 8B may be used.

FIG. 9 is a hardware system block diagram of the PC 2 as a communication device in the present embodiment.

The PC 2 includes a wireless LAN (WLAN) communication module 112, a Bluetooth (BT) communication module 113, a CPU 115, a memory 116, an input unit 117, and a display unit 118. The components of the PC 2 are connected through a bus 122.

The wireless LAN (WLAN) communication module 112 performs wireless LAN communication compliant with a predetermined standard, such as IEEE 802.11a/b/g, through an embedded antenna (not shown).

The Bluetooth (BT) communication module 113 wirelessly communicates with other communication devices existing in proximity (e.g., several to ten-odd meters) to the PC 2 through an embedded antenna.

The CPU (Central Processing Unit) 115 generates various control signals and supplies the signals to control the components of the PC 2. The CPU 115 executes various processes in accordance with programs stored in a ROM or various application programs or control programs including an operation system loaded from the ROM to a RAM.

The memory 116 is a storage device, such as a ROM, a RAM, a flash memory device, and an HDD.

The input unit 117 receives input through an input unit, such as a keyboard and a mouse, and outputs the input signal to the CPU 115. The display unit 118 displays data including characters, images, etc. under the control of the CPU 115. The display unit 118 is constituted by, for example, an LCD, an organic EL display, and an inorganic EL display.

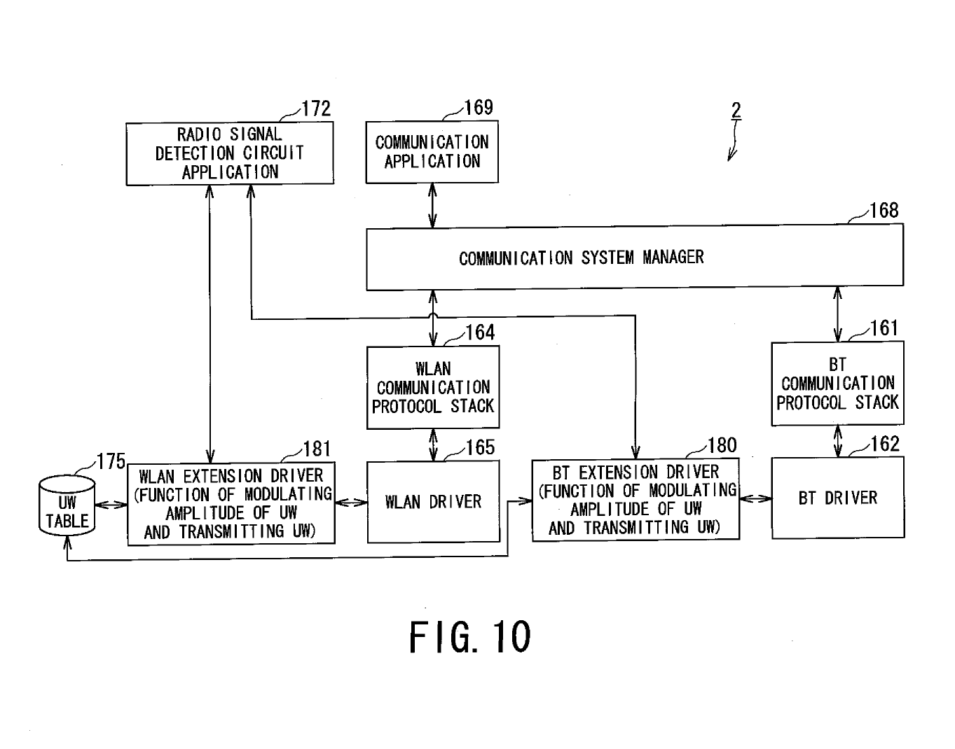

FIG. 10 is a software system block diagram of the PC 2 as a communication device in the present embodiment.

A configuration for realizing wireless communication with other communication devices will be mainly described for the PC 2 in the present embodiment, and details of a software system configuration generally included in PCs will not be described.

A WLAN communication protocol stack 161 executes a predetermined WLAN communication procedure. A wireless LAN (WLAN) driver 162 controls the WLAN communication module 112 to perform a procedure executed by the WLAN communication protocol stack 161. A wireless LAN (WLAN) extension driver 180 is a driver that modulates the amplitude of UWs and commands stored in a UW table 175 and that transmits the UWs and the commands from the WLAN communication module 112. The WLAN extension driver 180 modulates the amplitude of the UWs and the commands once or a plurality of times immediately after the activation depending on activation parameters of the WLAN communication module 112 and transmits the UWs and the commands from the WLAN communication module 112.

A Bluetooth (BT) communication protocol stack 164 executes a predetermined BT communication procedure. A Bluetooth (BT) driver 165 controls the BT communication module 113 to perform the procedure executed by the BT communication protocol stack 164. A Bluetooth (BT) extension driver 181 is a driver that modulates the amplitude of the UWs and the commands stored in the UW table 175 and that transmits the UW and the commands from the BT communication module 113 as each of UW signals. The BT extension driver 181 modulates the amplitude of the UWs and the commands once or a plurality of times immediately after the activation in accordance with activation parameters of the BT communication module 113 and transmits the UWs and the commands from the BT communication module 113.

A communication system manager 168 manages the WLAN communication protocol stack 161 and the BT communication protocol stack 164. A communication application 169 directly receives, for example, a communication instruction from the user and notifies the communication system manager 168 of the instruction.

A radio signal detection circuit application 172 receives, for example, a UW registration instruction and input data from the user and notifies the WLAN extension driver 180 or the BT extension driver 181 of the instruction and the data. The unique word (UW) table 175 stores UWs set by the user and so on. During UW signal transmission, any command and UW read out from the UW table 175 are sent out based on an instruction from the user received by the radio signal detection circuit application 172 or based on the determination of the application.

During wireless LAN communication, the cell phone 1 and the PC 2 operate in one of a “terminal mode”, an “access point (AP) mode”, and an “ad hoc mode”.

The “terminal mode” is a mode for actively or passively scanning a beacon signal transmitted from a terminal (from AP master, ad hoc master) operating in the AP mode or the ad hoc mode. The “AP mode” is a mode for operating as an access point (AP) and transmitting a beacon signal to other terminal (to AP slave). The AP mode includes not only a case in which the terminal functions as a relay base station of data communication as an actual AP, but also a case in which the terminal behaves as an AP. The case in which the terminal behaves as the AP is a case in which, for example, the terminal transmits a beacon signal but does not actually operate as a relay base station of data communication. The “ad hoc mode” is a mode during ad hoc network formation for communication between terminals (between ad hoc master and slave).

The “AP master” denotes a terminal that operates in the AP mode and that transmits a beacon signal to AP slave. The “AP slave” denotes a terminal that operates in the terminal mode and that scans the beacon signal transmitted from the AP master. The “ad hoc master” denotes a terminal that operates in the ad hoc mode and that transmits a beacon signal to other terminals (to ad hoc slave). The “ad hoc slave” denotes a terminal that operates in the ad hoc mode and that scans the beacon signal transmitted from other terminals (from ad hoc master).

The operation mode of the cell phone 1 and the PC 2 during Bluetooth communication will be called a “BT mode”.

A description here is made on a case where device authentication necessary for communication by the WLAN communication modules 12 and 112 are set in advance in the cell phone 1 and the PC 2. For example, if the cell phone 1 and the PC 2 are in accordance with WPS (Wi-Fi Protected Setup), the device authentication is set using the WPS. The WPS is a method of setting ESSID (Extended Service Set Identification) (or SSID), WPA (Wi-Fi Protected Access), etc. by inputting, for example, a PIN code (PIN: Personal Identification Number). The user can use the WPS to easily establish a secure WLAN network. The PIN code may be inputted during each authentication process for executing a process of connecting with another terminal.

A description here is made on a case where that device authentication (pairing) necessary for specifying a connection partner in the communication by the BT communication modules 13 and 113 is set in advance in the cell phone 1 and the PC 2. For example, the device authentication is set by inputting a PIN code after mutual search of devices.

In the following paragraph, processes of the cell phone 1 and the PC 2 when the PC 2 performs data communication (e.g., network communication) using the mobile communication network of the cell phone 1 will be described. The processes are performed in a case where the cell phone 1 receives the WLAN signal or the BT signal from the PC 2. Processes in a case where the cell phone 1 receives UW signal will be described in a later paragraph.

The cell phone 1 in the present embodiment uses the radio signal detection circuit 23 that can wait for a radio signal transmitted all the time from the PC 2 with low power consumption. As a result, the cell phone 1 doesn't require always activation of the communication modules 12 and 13 and a user operation of activating the communication modules 12 and 13. More specifically, the cell phone 1 monitors a predetermined signal transmitted from the PC 2 through the radio signal detection circuit 23 in place of the WLAN communication module 12 and the BT communication module 13.

The PC 2 is designed to request connection to the cell phone 1 by transmitting one of the following four types of signals that can be detected by the radio signal detection circuit 23 of the cell phone 1. The first radio signal is a probe request signal transmitted when the PC 2 operates in the terminal mode for active scan as an AP slave. The second radio signal is a beacon signal transmitted when the PC 2 unit operates in the AP mode as an AP master. The third radio signal is a beacon signal transmitted when the PC 2 operates in the ad hoc mode as an ad hoc master. The fourth radio signal is an inquiry signal transmitted during inquiry by the PC 2 in the BT mode.

When one of the four types of signals is received by the radio signal detection circuit 23, the cell phone 1 execute a connection process using the following three communication methods depending on priorities to establish connection with the PC 2. If the radio signal detection circuit 23 is designed to be capable of identifying the type of the radio signal, the cell phone 1 may select a communication method used according to the type of the radio signal (described in detail later).

The first communication method is a method of establishing connection with the PC 2, in which the WLAN communication module 12 of the cell phone 1 operates as an AP for the WLAN communication module 112 of the PC 2 or as a terminal for the AP as required. The second communication method is a method of establishing connection with the PC 2, in which the cell phone 1 operates in the ad hoc mode as an ad hoc slave. The third communication method is a method, in which the cell phone 1 uses both the BT communication module 13 and the WLAN communication module 12 as the situation demands. In any method, the cell phone 1 and the PC 2, respectively, switches operation mode to the AP mode and to the terminal mode as required after the establishment of connection (described in detail later). This is to establish faster and more reliable communication.

The cell phone 1 sequentially uses the three communication methods based on preset priorities to attempt connecting with the PC 2. The priorities are set during preliminary authentication setting of the cell phone 1 and the PC 2, or the user sets the priorities through a predetermined application as required.

A description here is made on a case where the priorities are set in the order of the first communication method, the second communication method, and the third communication method in the example. More specifically, in the description of the applied example, the second communication method is used if the establishment of connection using the first communication method has failed, and the third communication method is used if the second communication method has failed. Only one of the three communication methods may be used, or the three communication methods may be used in a predetermined order as described below.

In the following each description of the connection process using each communication method, the PC 2 transmits a type of signal which is available in the communication method to the radio signal detection circuit 23. And actually, the PC 2 transmits one type of radio signal successively for a predetermined time as a communication request. Then the cell phone 1 detects the type of radio signal and executes the connection process using the above mentioned communication methods depending on the priorities. If the connection process using one of the communication methods is successful, the radio signal detection circuit 23 again waits for a radio signal transmitted from the PC 2 after the completion of data communication. Then, if the radio signal detection circuit 23 detects the predetermined radio signal, the cell phone 1 executes the connection process using the communication method with the highest priority again.

A connection process of the cell phone 1 and the PC 2 using the first communication method will be described first.

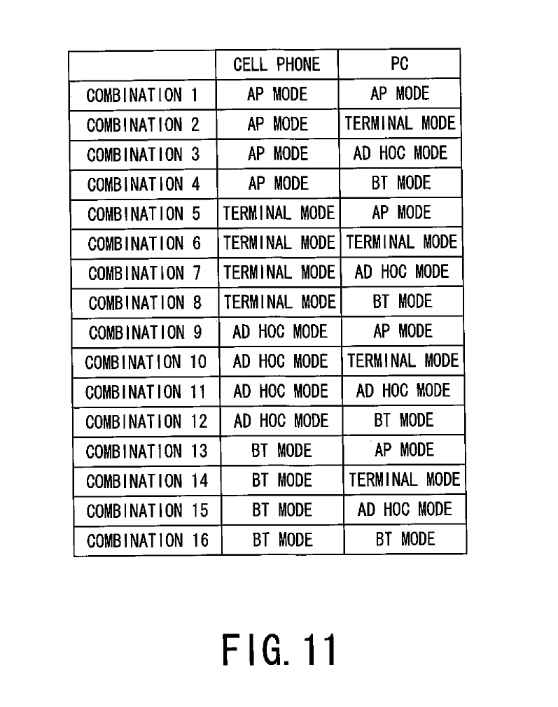

FIG. 11 is a diagram for explaining combinations of operation modes that can be taken by the cell phone 1 and the PC 2. FIG. 11 will be referenced as required in the following description.

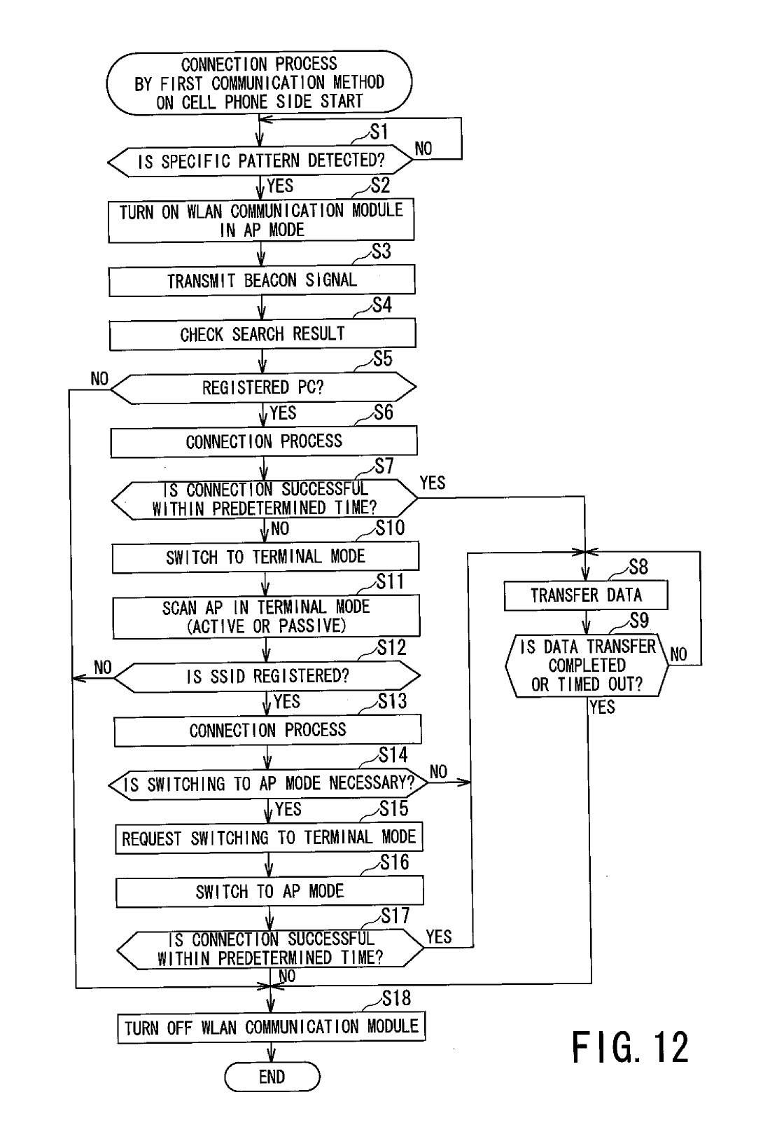

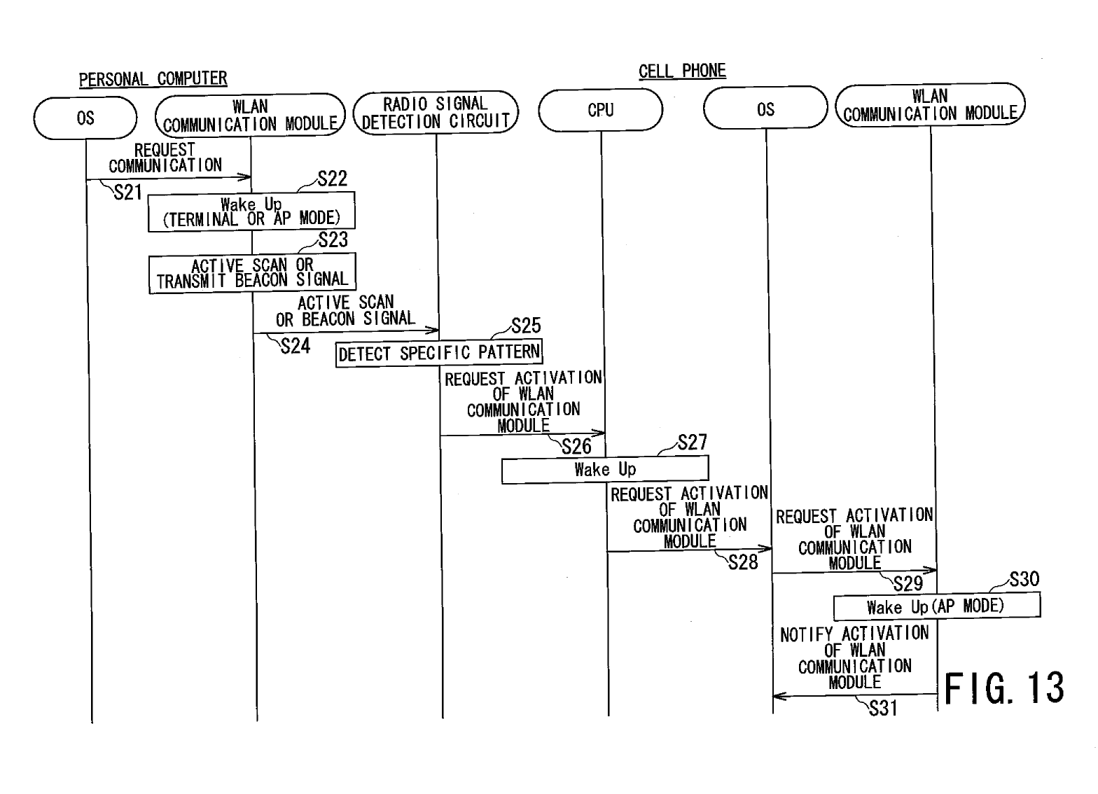

FIG. 12 is a flow chart for explaining a connection process using the first communication method executed in the cell phone 1 of the present embodiment.

Although the radio signal detection circuit 23, the CPU 15, an OS, and the WLAN communication module 12 mainly execute the processes in the following description of the processes, required software programs also execute the processes.

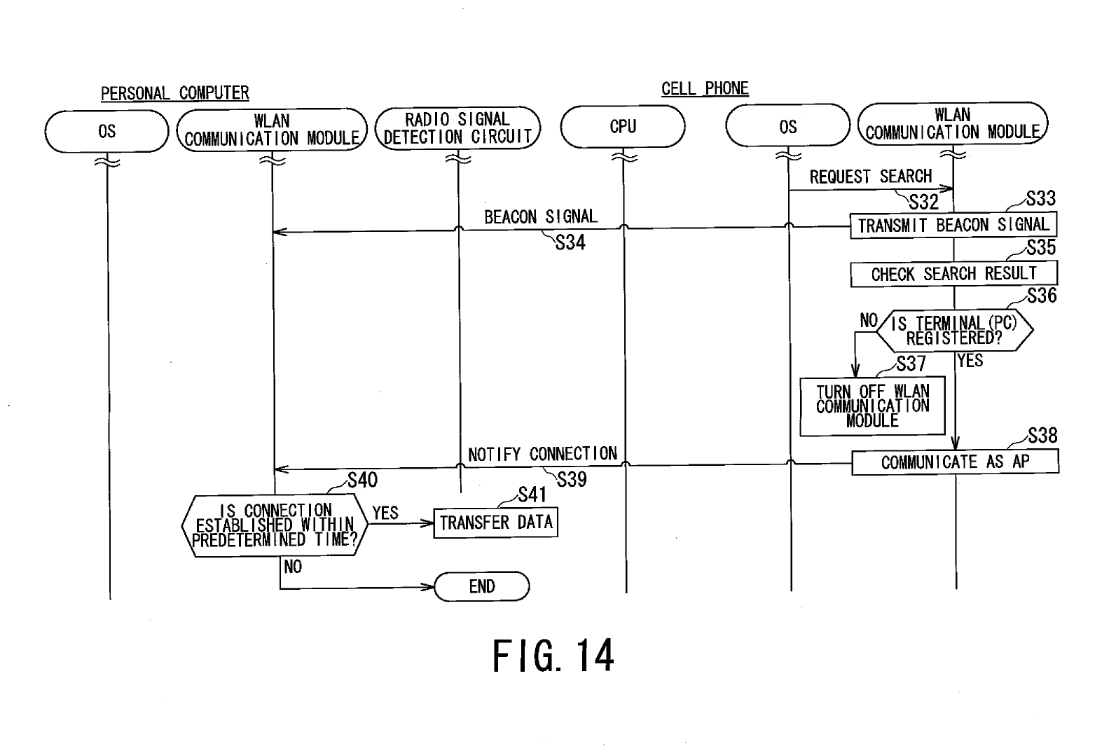

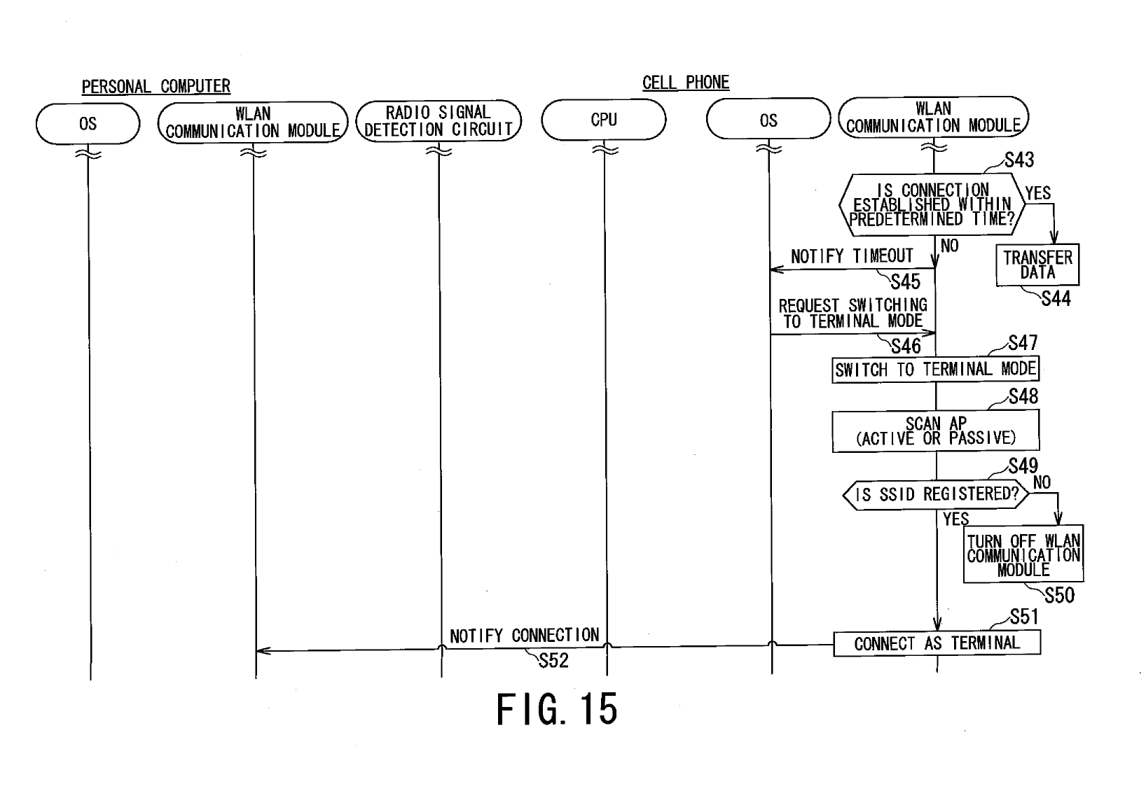

FIG. 13 is a sequence diagram showing a connection process using the first communication method executed between the cell phone 1 and the PC 2. FIG. 14 is a sequence diagram showing a process following FIG. 13. FIG. 15 is a sequence diagram showing a process following FIG. 14.

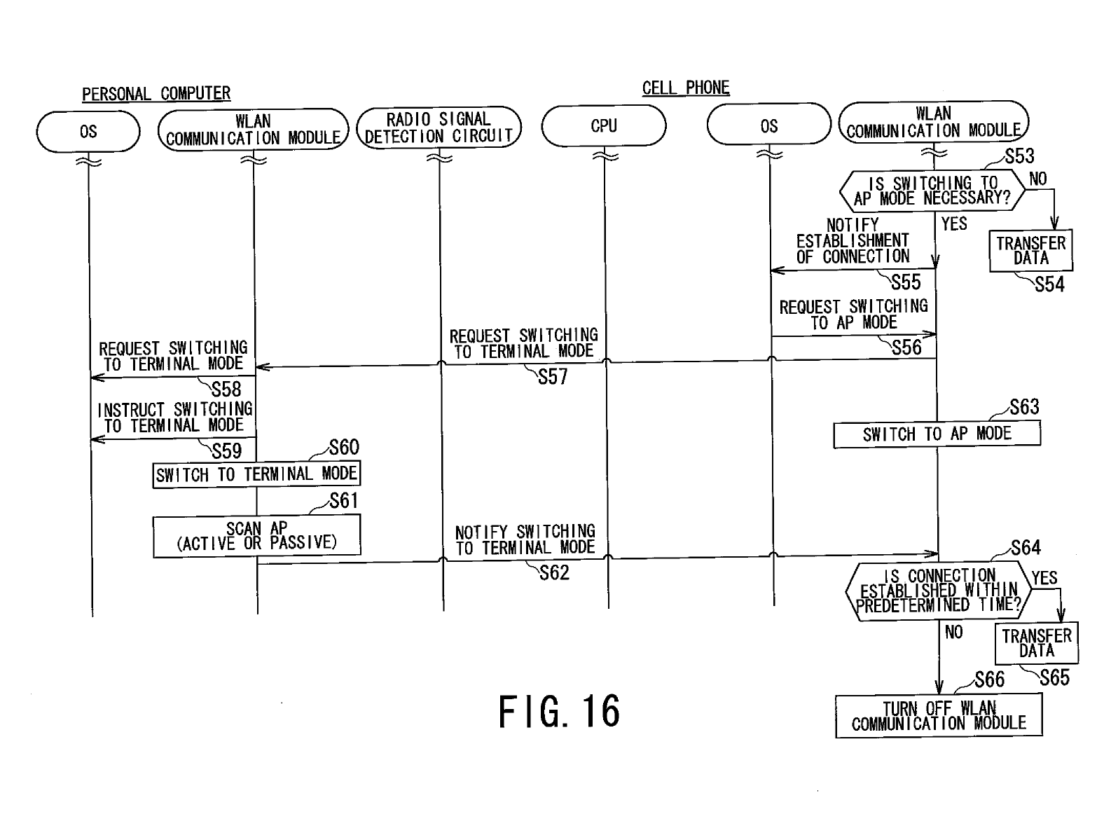

FIG. 16 is a sequence diagram showing a process following FIG. 15.

Main processes in the present embodiment will be particularly illustrated in the sequence diagram described below, and the other processes may not be described.

In step S1, the radio signal detection circuit 23 of the cell phone 1 determines whether a specific pattern of a radio signal is detected. If the specific pattern is not detected, the radio signal detection circuit 23 waits until the detection.

On the other hand, if the radio signal detection circuit 23 determines that the specific pattern is detected (S25 of FIG. 13), the WLAN communication module 12 is activated (Wake Up) in the AP mode based on the first communication method in step S2 (step S27 of FIG. 13). Specifically, when the specific pattern is detected (step S25), the radio signal detection circuit 23 generates an interruption signal and outputs a control signal to the interruption signal generation circuit 14. The interruption signal generation circuit 14 outputs the interruption signal to the CPU 15 (step S26). The CPU 15 turns on if the CPU 15 is in a sleep state (step S27).

The CPU 15 outputs an activation request signal for the WLAN communication module 12 through the OS (steps S28 and S29). After turning on, the WLAN communication module 12 issues an activation notification to the OS along with the activation (step S31). Operation modes that can be taken by the cell phone 1 and the PC 2 at this point are combinations 1 to 4 of FIG. 11.

In step S3, the WLAN communication module 12 transmits a beacon signal as an AP and informs surrounding terminals of required information (steps S33 and S34 of FIG. 14). The beacon signal is transmitted based on a search request outputted from the OS (step S32 of FIG. 14).

In step S4, the WLAN communication module 12 checks a search result of other terminals (response from other terminals) based on the beacon signal (step S35). In step S5, the WLAN communication module 12 determines whether the searched terminal is the PC 2 as a terminal registered in advance (step S36). The process proceeds to step S18 if the WLAN communication module 12 determines that the terminal is not the registered PC 2, and the power of the WLAN communication module 12 is turned off (step S37). Although not shown, the process proceeds to, for example, step S10 if the search result is not obtained within a predetermined time, and the operation mode is switched to the terminal mode.

On the other hand, if the WLAN communication module 12 determines that the searched terminal is the PC 2 registered in advance, the WLAN communication module 12 starts communicating as the AP with the PC 2 in step S6 (step S38) and executes a predetermined connection process to communicate with the PC 2. Since a known method (authentication, association) is used in the procedure of the wireless LAN connection process between the cell phone 1 and the PC 2, details will not be described here. The cell phone 1 and the PC 2 at this point are in the combination 2 of FIG. 11.

In step S7, the WLAN communication module 12 determines whether the connection with the PC 2 has succeeded within a predetermined time (step S43 of FIG. 15). If the cell phone 1 determines that the connection is successful, the cell phone 1 as the AP causes the PC 2 to transfer data (data communication) through the mobile communication network in step S8 (step S44). In step S9, the WLAN communication module 12 determines whether the data transfer is completed or a preset time has passed (timed out) since the last data transfer. The completion of the data transfer can be determined based on the presence of the detection of user input, a beacon signal in the radio signal detection circuit 23, etc. If the WLAN communication module 12 determines that the data transfer is not completed or the time has not passed, the process returns to step S8, and the data transfer is continued. If the WLAN communication module 12 determines that the data transfer is completed or timed out, the power of the WLAN communication module 12 is turned off in step S18. After the power of the WLAN communication module 12 is turned off, the radio signal detection circuit 23 returns to the standby state of a radio signal.

If the WLAN communication module 12 determines that the connection with the PC 2 within the predetermined time has failed in the connection determination step S7, the WLAN communication module 12 notifies the OS of the timeout (step S45 of FIG. 15). Accordingly, the WLAN communication module 12 receives a request of switching to the terminal mode from the OS (step S46). In step S10, the operation mode is switched to the terminal mode (step S47). Since the connection process with the PC 2 has failed in the AP mode, the cell phone 1 changes the operation mode to the terminal mode to attempt the connection.

In the description of the applied example, the cell phone 1 switches to the terminal mode if it is determined in the connection determination step S7 that the connection to the PC 2 has failed. However, the cell phone 1 may return to the specific pattern detection step S1 to repeat the subsequent process. More specifically, if the connection to the PC 2 has failed, the cell phone 1 may not switch to the terminal mode to execute the connection process with the PC 2 again. In that case, the cell phone 1 turns off the WLAN communication module 12 and shifts to the standby state of the beacon signal in the radio signal detection circuit 23. This is to prevent an increase in the amount of power consumption by repeating unnecessary processes when the radio signal detection circuit 23 falsely detects a signal that is not a beacon signal.

In step S11, the WLAN communication module 12 performs active scan or passive scan to scan a usable AP (step S48). In step S12, the WLAN communication module 12 determines whether the SSID included in the beacon signal obtained by scanning corresponds to the SSID registered in advance in the cell phone 1 (step S49). If the WLAN communication module 12 determines that the obtained SSID is different from the registered SSID, the process proceeds to step S18, and the power of the WLAN communication module 12 is turned off (step S50). An example of the case is that when the scanned AP is not the PC 2. Although not shown, if the scan result is not obtained within a predetermined time in step S11, the process proceeds to step S18, and the power of the WLAN communication module 12 is turned off.

On the other hand, if the WLAN communication module 12 determines that the obtained SSID corresponds to the registered SSID, the WLAN communication module 12 executes a connection process as a terminal for the PC 2 as an AP in step S13 (step S51) and transmits a connection notification to the WLAN communication module 112 of the PC 2 (step S52). The cell phone 1 and the PC 2 at this point are in the combination 5 of FIG. 11.

In step S14, the WLAN communication module 12 determines whether switching to the AP mode is required to cause the PC 2 to perform data communication using a mobile communication network (step S53 of FIG. 16). The determination of whether switching to the AP mode is required is made based on the presence of timeout of a timer that measures a predetermined time or based on a predetermined number of times of communication checking. If the WLAN communication module 12 determines that switching to the AP mode is not required, the WLAN communication module 12 proceeds to the data transfer step S8 and operates in the terminal mode to communicate with the PC 2.

On the other hand, if the WLAN communication module 12 determines that switching to the AP mode is required, the WLAN communication module 12 issues a connection establishment notification to the OS (step S55). The OS requests the WLAN communication module 12 to switch the operation mode to the AP mode (step S56). In step S15, the WLAN communication module 12 requests the WLAN communication module 112 of the PC 2 to switch the operation mode to the terminal mode (step S57). Accordingly, the PC 2 switches the operation mode to the terminal mode and issues a terminal mode switch notification to the WLAN communication module 12 of the cell phone 1 (step S62).

In step S16, the WLAN communication module 12 switches the operation mode to the AP mode (step S63). In step S17, the WLAN communication module 12 determines whether the connection to the PC 2 has succeeded within a predetermined time (step S64). If the connection is determined to be successful, the cell phone 1 proceeds to step S8 and causes the PC 2 to transfer data through the mobile communication network as an AP (step S65). The operation mode of the cell phone 1 and the PC 2 at this point is the combination 2 of FIG. 11.

On the other hand, if the WLAN communication module 12 determines that the connection has not succeeded within the predetermined time, the WLAN communication module 12 is turned off in step S18 (step S66).

Processes when the PC 2 operates in the terminal mode and the AP mode that are operation modes for transmitting a connectable radio signal while the cell phone 1 uses the first communication method will be described.

First, a process when the PC 2 operates in the terminal mode that is an operation mode for transmitting a connectable radio signal while the cell phone 1 uses the first communication method will be described.

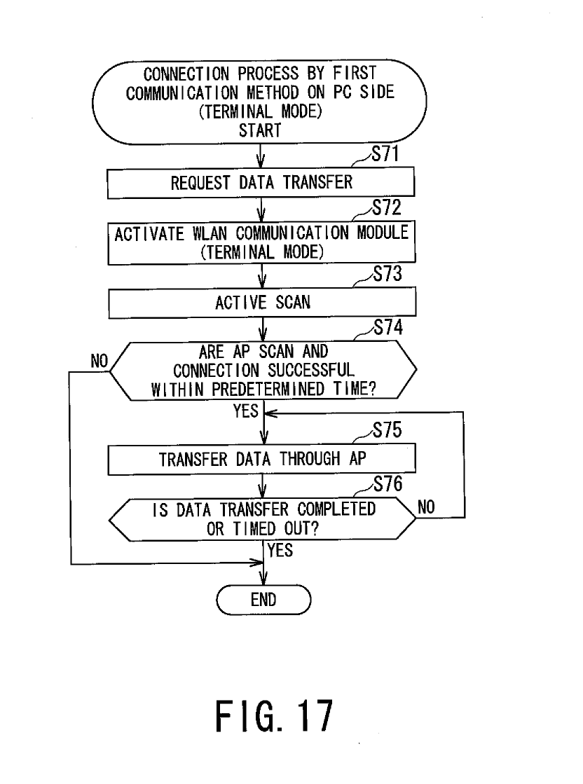

FIG. 17 is a flow chart for explaining a connection process by the first communication method during the terminal mode operation executed in the PC 2 of the present embodiment.

Although the OS and the WLAN communication module 112 mainly execute the processes in the following description of the processes, required software programs also execute the process.

The sequence diagrams of FIGS. 13 to 16 illustrate processes in which the WLAN communication module 112 of the PC 2 operates in the terminal mode or the AP mode.

In step S71, the OS of the PC 2 receives a data transfer (data communication) request (step S21 of FIG. 13). In step S72, the WLAN communication module 112 is activated based on the control of the OS (step S22). At this point, the WLAN communication module 112 (PC 2) is activated in the terminal mode.

Specifically, when the PC 2 receives the data transfer request, the PC 2 may determine whether there is a destination with higher priority than that of the cell phone 1 operates as a modem among the destinations registered in the PC 2. The priorities of the destinations are information set in advance by the user or originally held by the PC 2. If the PC 2 determines that another destination with higher priority exists, the PC 2 executes a connection process to communicate with the destination. For example, if the PC 2 determines that there is an access point with higher priority than that of the cell phone 1 operates as a modem, the PC 2 responds to the communication request by communicating with the access point.

In step S73, the WLAN communication module 112 performs active scan to scan a usable AP (step S23). The WLAN communication module 112 continues scanning for a predetermined time. The WLAN communication module 112 may send out the WLAN signal for a plurality of times to prevent false detection or missed detection of the scan signal in a scan partner such as the cell phone 1. The WLAN communication module 112 transmits a probe request signal and waits for a probe response signal transmitted from other terminals. The WLAN communication module 112 that has received a communication request can also perform passive scan. In that case, the WLAN communication module 112 can wait for a beacon signal transmitted from an AP other than the cell phone 1 and perform data communication after a predetermined connection process if the AP is connectable.

The active scan executed by the WLAN communication module 112 in step S73 may be a scan for detecting the cell phone 1 or a scan for detecting an AP other than the cell phone 1. The PC 2 does not have to particularly take the scan destination into consideration.

In step S74, the WLAN communication module 112 determines whether the AP is scanned within the predetermined time and the connection to the scanned AP is successful (step S40 of FIG. 14). The scanned and connected AP here is the cell phone 1 as an AP in some cases and is another AP different from the cell phone 1 in other cases. If a plurality of APs including the cell phone 1 are detected, the PC 2 may preferentially connect to the cell phone 1 based on a preset condition or may preferentially connect to an AP other than the cell phone 1. The user may select the destination. A known method is used for the connection process (SSID check, authentication, association) of the PC 2 and the AP (cell phone 1), and details will not be described. If the connection to the AP is successful, the WLAN communication module 112 transfers data through the connected AP in step S75 (step S41). For example, the PC 2 causes the cell phone 1 to operate as a modem, and a common carrier network can be used through the mobile communication module 11 of the cell phone 1.

In step S76, the WLAN communication module 112 determines whether the data transfer is completed or a preset time has passed (timed out) since the last data transfer. If the WLAN communication module 112 determines that the data transfer is not completed or the time has not passed, the process returns to step S75, and the data transfer is continued. The process ends if the WLAN communication module 112 determines that the data transfer is completed or timed out.

On the other hand, if the WLAN communication module 112 determines that the connection to the AP is not made within the predetermined time in the connection determination step S74, the process ends because the establishment of connection with the AP including the cell phone 1 has failed.

A process when the PC 2 operates in the AP mode that is an operation mode for transmitting a connectable radio signal while the cell phone 1 uses the first communication method will be described.

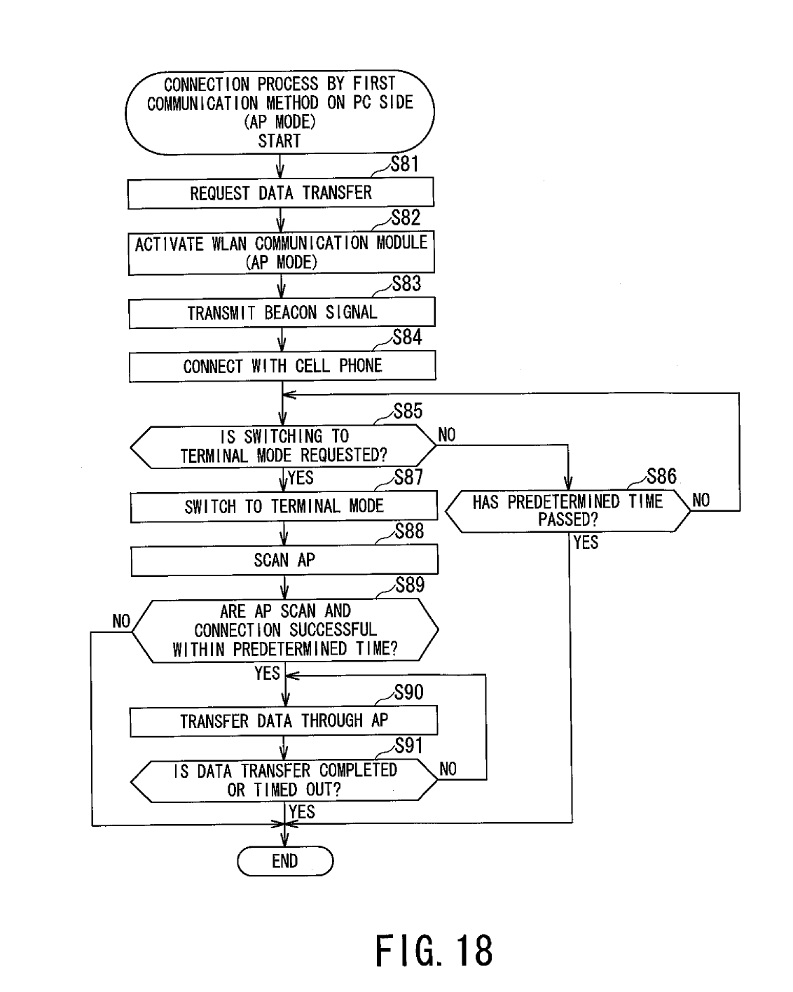

FIG. 18 is a flow chart for explaining a connection process by the first communication method during the AP mode operation executed in the PC 2 of the present embodiment.

In step S81, the OS of the PC 2 receives a data transfer request (step S21 of FIG. 13). In step S82, the WLAN communication module 112 is activated based on the control of the OS (step S22). At this point, the WLAN communication module 112 (PC 2) is activated in the AP mode.

In step S83, the WLAN communication module 112 transmits a beacon signal for informing surrounding terminals of required information (step S23). At this point, the cell phone 1 operates in the terminal mode (combination 5 of FIG. 11). Therefore, in step S84, the WLAN communication module 112 of the PC 2 as an AP receives a notification of the establishment of the connection from the cell phone 1 (step S52 of FIG. 15).

In step S85, the WLAN communication module 112 determines whether a request for switching to the terminal mode is received from the cell phone 1. If the WLAN communication module 112 determines that the switch request of the terminal mode is not received, the WLAN communication module 112 determines whether a predetermined time has passed since the start of the transmission of the beacon signal in step S86. If the WLAN communication module 112 determines that the predetermined time has not passed, the process returns to the switch request determination step S85. On the other hand, if the WLAN communication module 112 determines that the predetermined time has passed, the process ends because the establishment of the connection with the cell phone 1 has failed.

If the WLAN communication module 112 determines that the switch request to the terminal mode is received from the cell phone 1 in the switch request determination step S85 (step S57 of FIG. 16), the WLAN communication module 112 switches the operation mode from the AP mode to the terminal mode in step S87 (steps S58, S59, and S60). The WLAN communication module 112 also issues a terminal mode switch notification to the WLAN communication module 12 of the cell phone 1 (step S62).

In step S88, the WLAN communication module 112 performs active scan or passive scan to scan a usable AP (step S61). In step S89, the WLAN communication module 112 determines whether the connection to the scanned AP, i.e. the cell phone 1, has succeeded within the predetermined time. At this point, the cell phone 1 is designed to operate in the AP mode (combination 2 of FIG. 11). Therefore, the WLAN communication module 112 of the PC 2 is capable of connection with the cell phone 1 as an AP. If the WLAN communication module 112 determines that the connection to the AP has failed, the process ends because the establishment of the connection using the first communication method has failed.

On the other hand, if the WLAN communication module 112 determines that the connection to the AP is successful, the WLAN communication module 112 transfers data through the connected AP in step S90. In step S91, the WLAN communication module 112 determines whether the data transfer is completed or a preset time has passed (timed out) since the last data transfer. If the WLAN communication module 112 determines that the data transfer is not completed or the time has not passed, the process returns to step S90, and the data transfer is continued. The process ends if the WLAN communication module 112 determines that the data transfer is completed or timed out.

In the connection process of FIG. 16, the operation mode of the PC 2 is switched from the AP mode to the terminal mode when the PC 2 receives the request for switching to the terminal mode transmitted from the WLAN communication module 12 of the cell phone 1. However, the PC 2 may control operation mode to automatically switch from the AP mode to the terminal mode after a predetermined time. In that case, the process of the WLAN communication module 12 of the cell phone 1 transmitting the terminal mode switch request is skipped.

A connection process of the cell phone 1 and the PC 2 using the second communication method will be described.

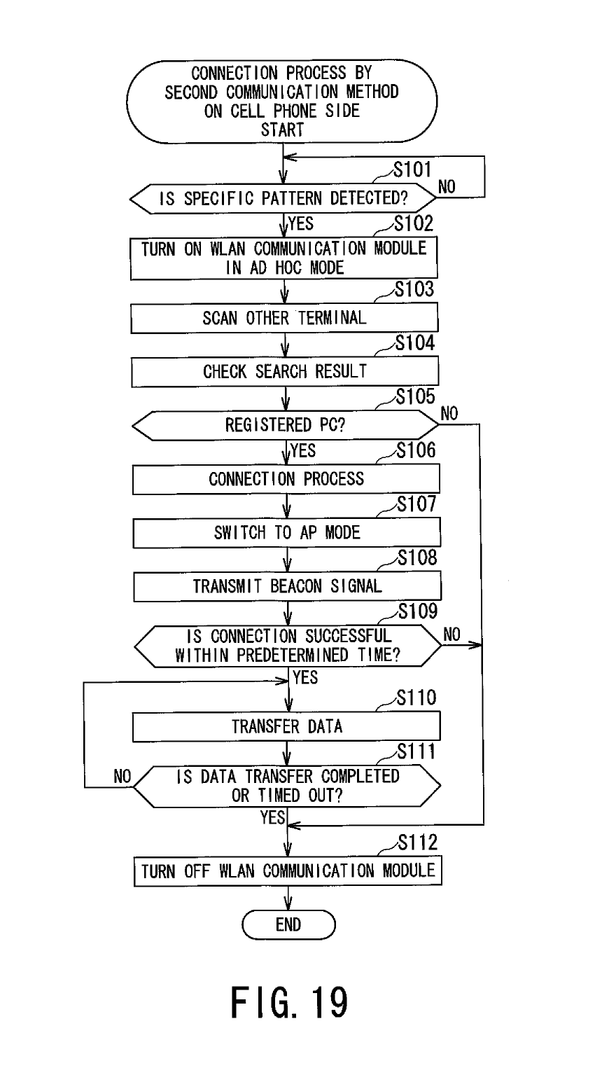

FIG. 19 is a flow chart for explaining a connection process using the second communication method executed in the cell phone 1 of the present embodiment.

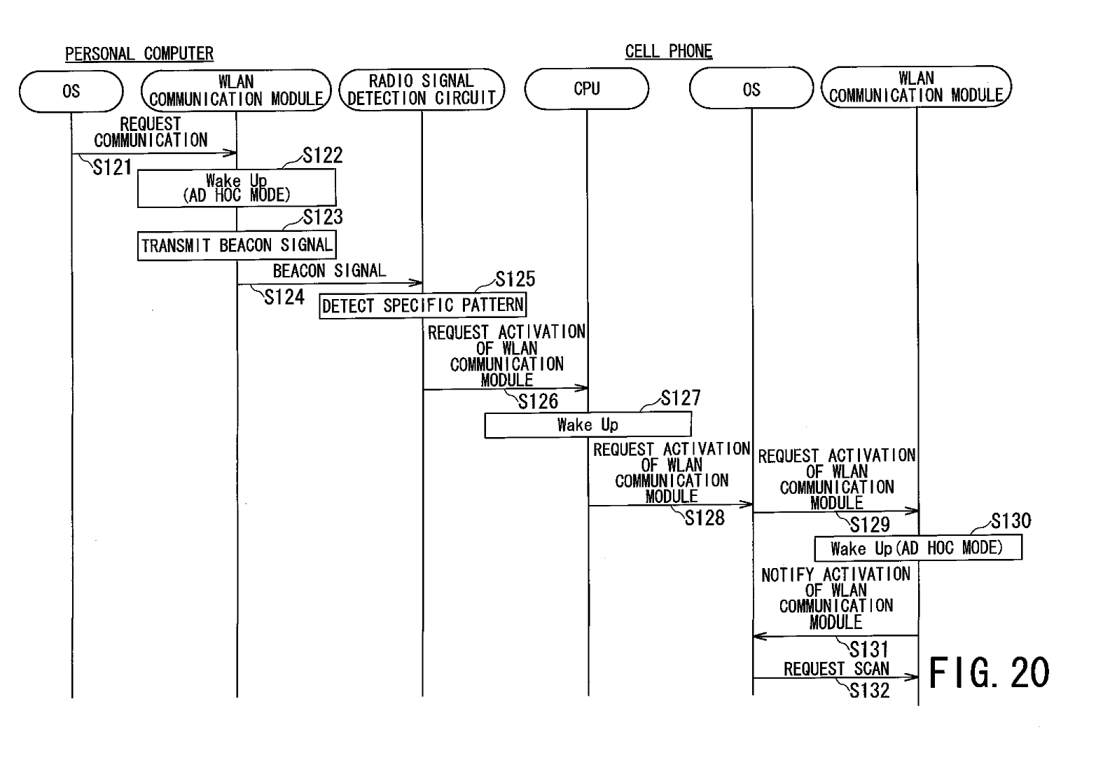

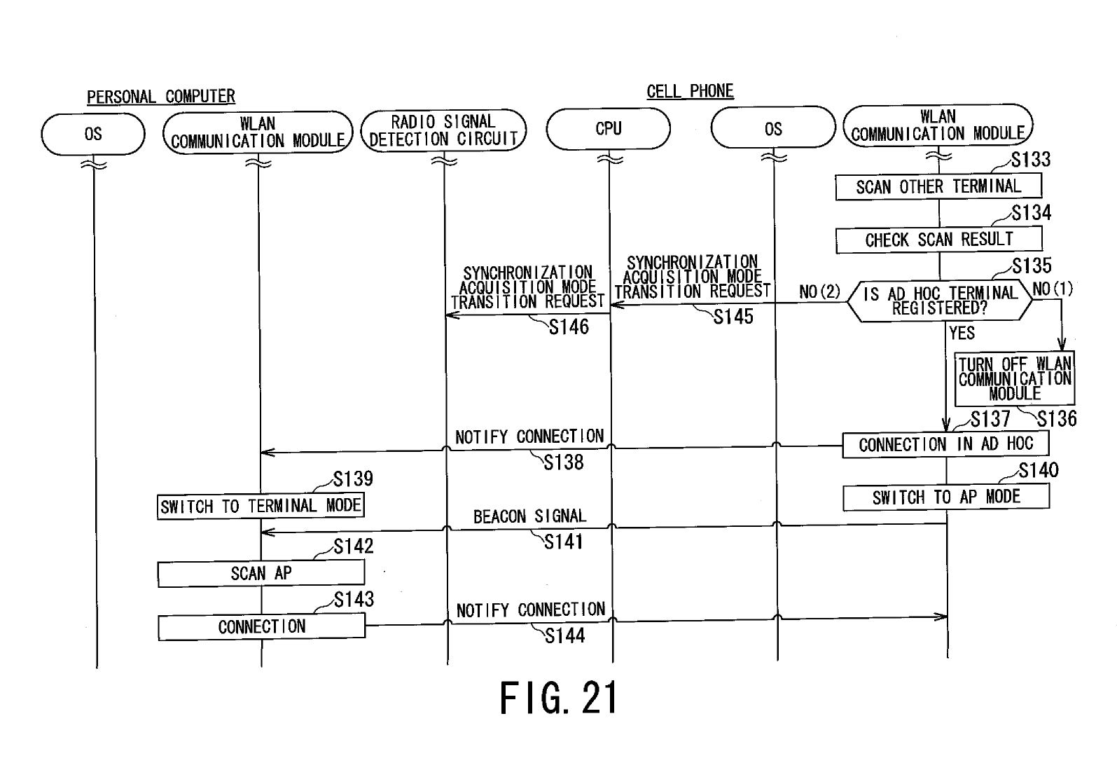

FIG. 20 is a sequence diagram showing a process using the second communication method executed between the cell phone 1 and the PC 2. FIG. 21 is a sequence diagram showing a process following FIG. 20.

In step S101, the radio signal detection circuit 23 of the cell phone 1 determines whether specific patterns of radio signals are detected. If the radio signal detection circuit 23 determines that the specific patterns are not detected, the radio signal detection circuit 23 waits until the detection.

On the other hand, if the radio signal detection circuit 23 determines that the specific patterns are detected, the WLAN communication module 12 is activated (Wake Up) based on the second communication method in step S102 (step S130 of FIG. 20). At this point, the communication mode of the cell phone 1 operates in the ad hoc mode as an ad hoc slave. Specifically, when a specific pattern is detected (step S125), the radio signal detection circuit 23 generates an interruption signal and outputs a control signal to the interruption signal generation circuit 14. The interruption signal generation circuit 14 outputs the interruption signal to the CPU 15 (step S126). The CPU 15 is activated if the CPU 15 is in the sleep state (step S127). The CPU 15 outputs an activation request signal for the WLAN communication module 12 through the OS (steps S128 and S129). After turning on, the WLAN communication module 12 notifies the OS of the activation along with the activation (step S131). The operation modes that can be taken by the cell phone 1 and the PC 2 are combinations 9 to 12 of FIG. 11.

In step S103, the WLAN communication module 12 actively or passively scans other terminal that is capable of operating in the ad hoc mode (step S133).

The scan is performed based on a scan request outputted from the OS (step S132).

In step S104, the WLAN communication module 12 checks the result obtained by scanning (step S134 of FIG. 21). In step S105, the WLAN communication module 12 determines whether the scanned terminal is a registered terminal (i.e., the PC 2 in the present embodiment). If the WLAN communication module 12 determines that the searched terminal is not the PC 2 (No (1) of step S135), the process proceeds to step S112, and the power of the WLAN communication module 12 is turned off (step S136).

On the other hand, if the WLAN communication module 12 determines that the searched terminal is the PC 2 registered in advance, the WLAN communication module 12 executes a connection process with the PC 2 in step S106 (step S137) and transmits a connection notification to the WLAN communication module 112 of the PC 2 (step S138). The operation mode of the cell phone 1 and the PC 2 at this point is a combination 11 of FIG. 11.

In step S107, the cell phone 1 switches the operation mode to the AP mode (step S140). This is because switching to the AP mode can establish faster and more reliable communication compared to the ad hoc mode. In step S108, the WLAN communication module 12 transmits a beacon signal for the PC 2 (step S141).

In step S109, the WLAN communication module 12 determines whether the connection to the PC 2 has succeeded within a predetermined time: If the cell phone 1 determines that the connection is successful, in other words, if a connection notification is received from the WLAN communication module 112 of the PC 2 (step S144), the cell phone 1 causes the PC 2 to transfer data through a mobile communication network as an AP in step S110. The operation mode of the cell phone 1 and the PC 2 at this point is the combination 2 of FIG. 11.

In step S111, the WLAN communication module 12 determines whether the data transfer is completed or a preset time has passed (timed out) since the last data transfer. If the WLAN communication module 12 determines that the data transfer is not completed or the time has not passed, the process returns to step S110, and the data transfer is continued. If the WLAN communication module 12 determines that the data transfer is completed or timed out, the power of the WLAN communication module 12 is turned off in step S112.

When the scan result indicates a terminal different from the PC 2 in step S105, the connection is determined to be a failure, and the power of the WLAN communication module 12 is turned off. An example of the connection failure includes when the WLAN communication module 12 of the cell phone 1 receives a beacon signal transmitted from a terminal other than the PC 2, for which the connection is desired. Although the cell phone 1 does not intend to connect to terminals other than the PC 2, the radio signal detection circuit 23 detects the beacon signal as long as the transmission of the beacon signal continues from the other terminals, and the WLAN communication module 12 is activated every time.

Therefore, to prevent the unnecessary activation of the WLAN communication module 12, the WLAN communication module 12 can issue a synchronization acquisition mode transition request to the radio signal detection circuit 23 through the CPU 15 if it is determined in step S105 that the scan result does not indicate the PC 2 (steps S145 and S146 of FIG. 21). The radio signal detection circuit 23 that has received the request acquires the period of the beacon signal transmitted from terminal (other than the PC 2), for which the connection is not desired, and prevents notifying the CPU 15 of the beacon signal by ignoring the detection if the beacon signal is detected again. As a result, the unnecessary activation of the WLAN communication module 12 can be prevented, and reduction in power consumption can be realized.

Next, A process when the PC 2 operates in the ad hoc mode that is an operation mode for transmitting a connectable radio signal while the cell phone 1 uses the second communication method will be described.

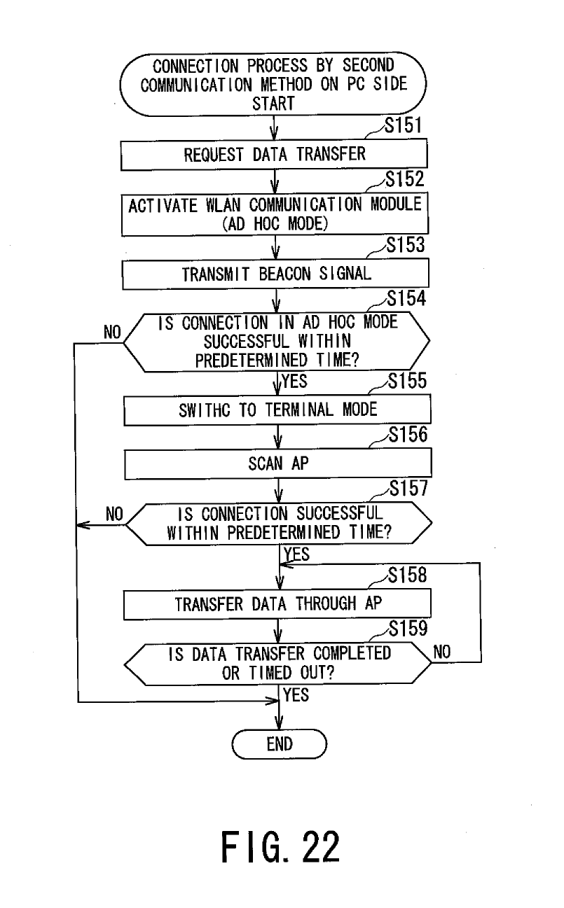

FIG. 22 is a flow chart for explaining a connection process by the second communication method during an ad hoc mode operation executed in the PC 2 of the present embodiment.

In step S151, the WLAN communication module 112 receives a data transfer (data communication) request from the OS (step S121 of FIG. 20).

In step S152, the WLAN communication module 112 is activated (Wake Up) based on the control of the OS (step S122). At this point, the WLAN communication module 112 (PC 2) is activated in the ad hoc mode based on the second communication method. In step S153, the WLAN communication module 112 transmits a beacon signal as an ad hoc master and informs surrounding terminals of required information (step S123 and S124).

In step S154, the WLAN communication module 112 determines whether the connection in the ad hoc mode to the cell phone 1 as other terminal has succeeded within a predetermined time.

In the second communication method, the cell phone 1 operates in the ad hoc mode (combination 1 of FIG. 11). The WLAN communication module 112 makes the determination based on the presence of a connection notification (step S138 of FIG. 21) transmitted from the WLAN communication module 12 of the cell phone 1 with respect to the transmitted beacon signal from the WLAN communication module 112. Since the PC 2 and the cell phone 1 used a known method for the connection process (authentication, association), details of that will not be described.

In the step S154, the process ends if the WLAN communication module 112 determines that the connection to the cell phone 1 within the predetermined time has failed.

On the other hand, if the WLAN communication module 112 determines that the connection to the cell phone 1 is successful, the WLAN communication module 112 (PC 2) switches the operation mode to the terminal mode in step S155 (step S139 of FIG. 21). As in the case of using the first communication method, the operation mode of the PC 2 may be switched based on the operation mode switch request (as step S57 of FIG. 16) transmitted from the WLAN communication module 12 of the cell phone 1, or the operation mode may be switched, for example, after a predetermined time from the beacon signal transmission.

In step S156, the WLAN communication module 112 performs active scan or passive scan to search a usable AP (step S142). In step S157, the WLAN communication module 112 determines whether the connection to the scanned AP, i.e. the cell phone 1, has succeeded within a predetermined time. At this point, the cell phone 1 is designed to operate in the AP mode (combination 2 of FIG. 11). Therefore, the WLAN communication module 112 of the PC 2 is capable of connection with the cell phone 1 as an AP. The process ends if the WLAN communication module 112 determines that the connection to the AP has failed.

On the other hand, if the WLAN communication module 112 determines that the connection to the AP is successful in step S157, the WLAN communication module 112 transfers data through the cell phone 1 as a AP in step S158. In step S159, the WLAN communication module 112 determines whether the data transfer is completed or a preset time has passed (timed out) since the last data transfer. If the WLAN communication module 112 determines that the data transfer is not completed or the time has not passed, the process returns to step S158, and the data transfer is continued. The process ends if the WLAN communication module 112 determines that the data transfer is completed or timed out.

Next, a wireless LAN connection process using the third communication method will be described.

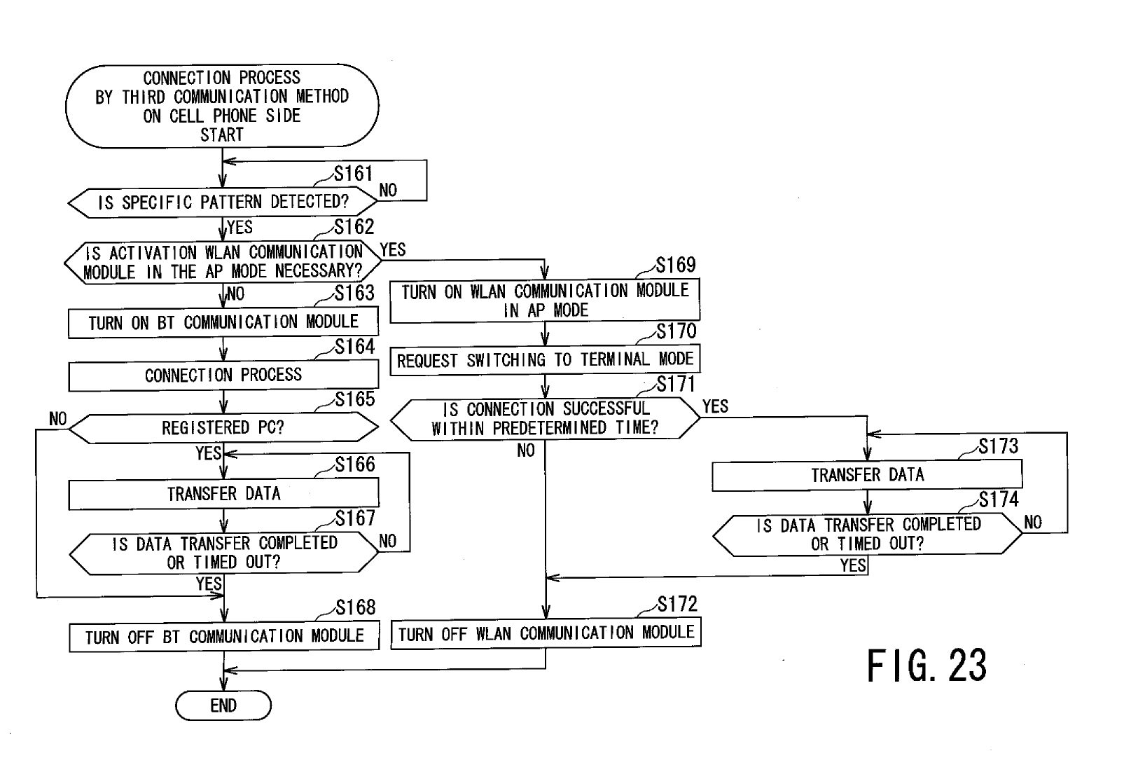

FIG. 23 is a flow chart for explaining a connection process using the third communication method executed in the cell phone 1 of the present embodiment.

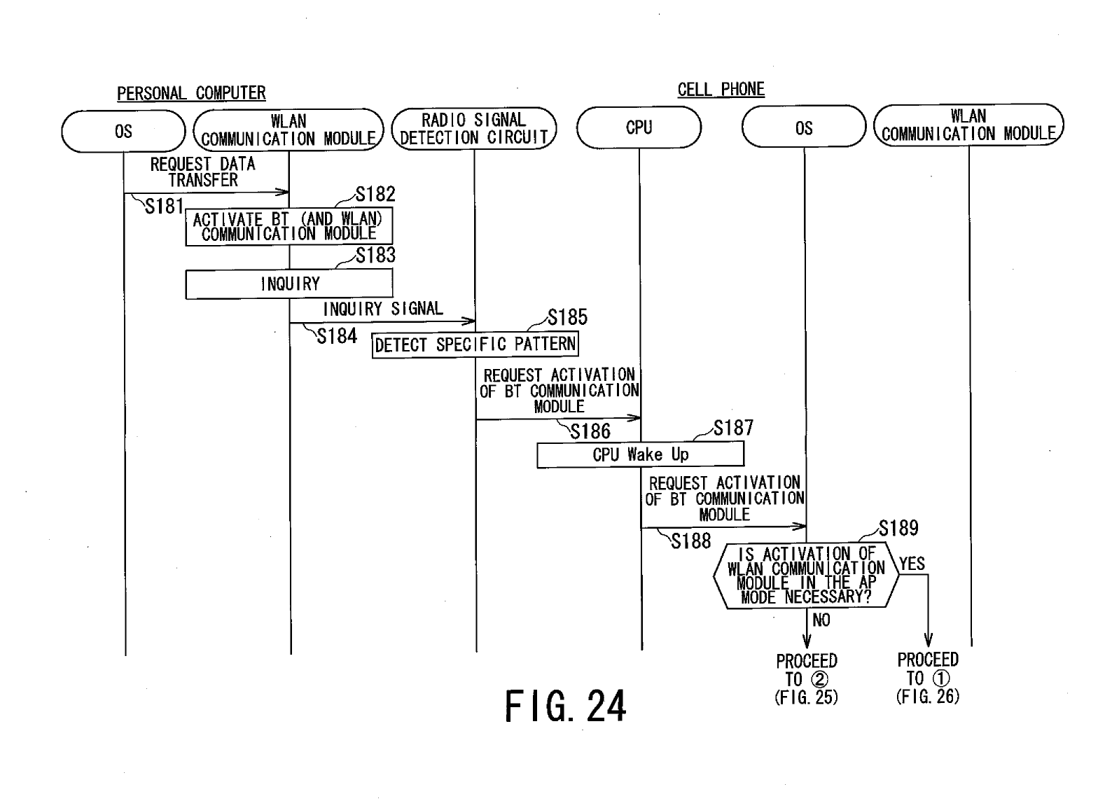

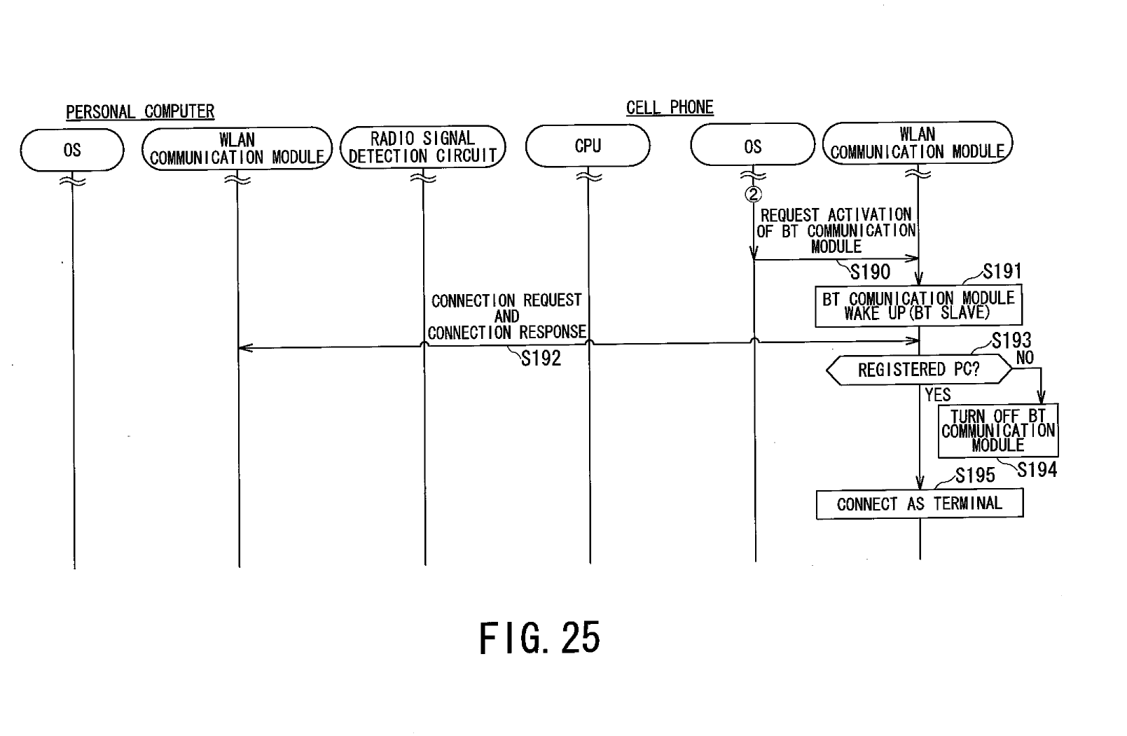

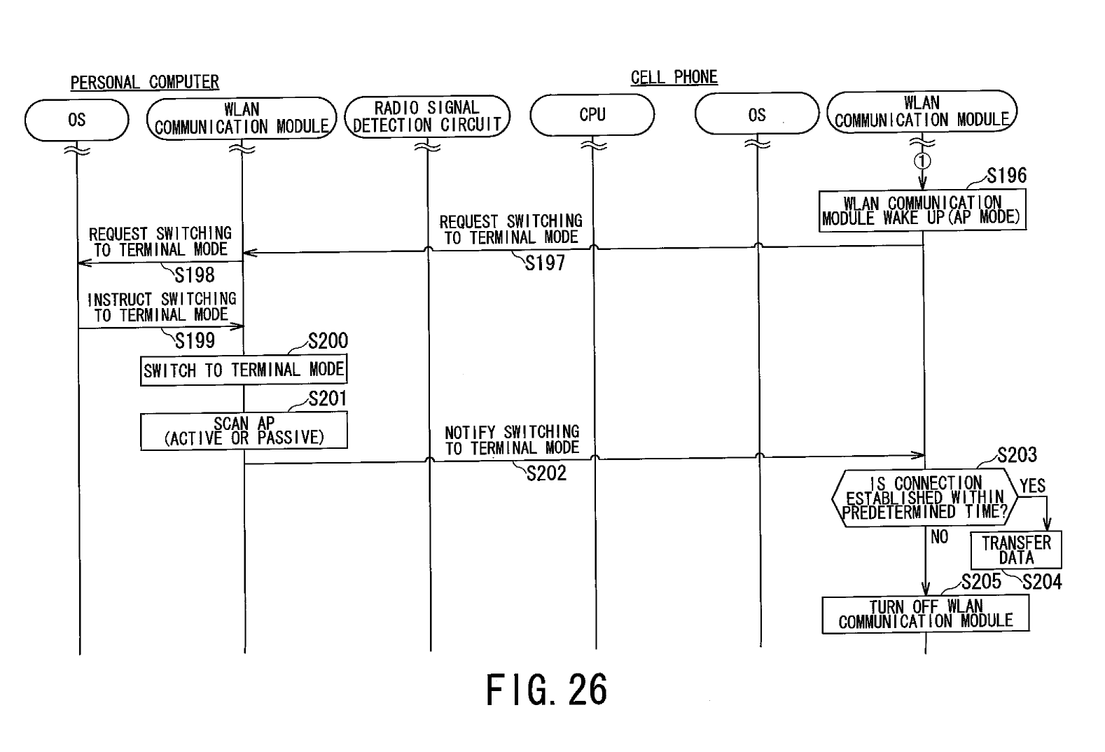

FIG. 24 is a sequence diagram showing a process using the third communication method executed between the cell phone 1 and the PC 2. FIG. 25 is a sequence diagram showing a process following FIG. 24. FIG. 26 is a sequence diagram showing a process following FIG. 25.

The wireless LAN connection process using the third communication method may perform data communication by each using the WLAN communication module 112 or the BT communication module 113. The sequence diagrams of FIGS. 24 and 25 illustrate a case of data transfer using a connection between the BT communication modules 13 and 113. The sequence diagram of FIG. 26 illustrates a case of data transfer using a connection between the WLAN communication modules 12 and 112.

In step S161, the radio signal detection circuit 23 of the cell phone 1 determines whether a specific pattern of a radio signal is detected. If the radio signal detection circuit 23 does not detect the specific pattern, the radio signal detection circuit 23 waits until the detection.

On the other hand, if the radio signal detection circuit 23 detects the specific pattern (step S185 of FIG. 24), the OS of the cell phone 1 determines whether the WLAN communication module 12 (cell phone 1) needs to be activated in the AP mode (whether switching to the AP mode is required) in step S162 to cause the PC 2 to perform data communication through the mobile communication network (step S189). Specifically, when the radio signal detection circuit 23 detects the specific pattern (step S185), the radio signal detection circuit 23 generates an interruption signal and outputs a control signal to the interruption signal generation circuit 14. The interruption signal generation circuit 14 outputs the interruption signal to the CPU 15 (step S186). The CPU 15 is activated if the CPU 15 is in the sleep state (step S187), and the CPU 15 outputs an activation request signal for the BT communication module 13 to the OS (step S188).

The OS determines whether the WLAN communication module 12 needs to be activated in the AP mode based on an original setting in the cell phone 1, an instruction from the user, etc in the step S162. If the OS determines that there is no need to switch to the AP mode, the BT communication module 13 is activated (Wake Up) as BT slave based on the activation request from the OS in step S163 (step S190 and S191 of FIG. 25).

In step S164, the BT communication module 13 executes a necessary connection process (connection request and connection response) with other terminal that performs an inquiry (step S192). If the PC 2 does not perform an inquiry using the BT communication module 113, the process ends after, for example, a predetermined time, because the connection is not established.

In step S165, the BT communication module 13 determines whether the terminal that executes the connection process is a registered terminal, i.e. the PC 2 in the present embodiment (step S193). If the BT communication module 13 determines that the terminal that executes the connection process is not the PC 2, the process proceeds to step S168, and the BT communication module 13 is turned off (step S194).

On the other hand, if the BT communication module 13 determines that the terminal that performs connection is the PC 2, the BT communication module 13 transfers data with the BT communication module 113 of the PC 2 in step S166, and data communication is performed through the mobile communication network based on the data transferred between the BT communication modules 13 and 113. The operation mode of the cell phone 1 and the PC 2 at this point is a combination 16 of FIG. 11.

In step S167, the BT communication module 13 determines whether the data transfer is completed or a preset time has passed (timed out) since the last data transfer. If the BT communication module 13 determines that the data transfer is not completed or the time has not passed, the process returns to step S166, and the data transfer is continued. If the BT communication module 13 determines that the data transfer is completed or timed out, the BT communication module 12 is turned off in step S168.

On the other hand, if it is determined in step S162 that the operation mode needs to be switched to the AP mode (WLAN communication module 12 is activated), the WLAN communication module 12 is activated to operate in the AP mode in step S169 (step S196 of FIG. 26). In step S170, the WLAN communication module 12 requests the WLAN communication module 112 of the PC 2 to switch to the terminal mode (step S197).

In step S171, the WLAN communication module 12 determines whether the connection to the PC 2 has succeeded within a predetermined time (step S203). If the WLAN communication module 12 determines that the connection has failed, the WLAN communication module 12 is turned off in step S172.

On the other hand, if the WLAN communication module 12 determines that the connection is successful, the WLAN communication module 12 transfers data with the WLAN communication module 112 of the connected PC 2 in step S173 (step S204) to perform data communication through the mobile communication network. The operation mode of the cell phone 1 and the PC 2 at this point is the combination 2 of FIG. 11.

In step S174, the WLAN communication module 12 determines whether the data transfer is completed or a preset time has passed (timed out) since the last data transfer. If the WLAN communication module 12 determines that the data transfer is not completed or the time has not passed, the process returns to S173, and the data transfer is continued. If the WLAN communication module 12 determines that the data transfer is completed or timed out, the WLAN communication module 12 is turned off in step S172.

Next, a process when the PC 2 operates in the BT mode that is an operation mode for transmitting a connectable radio signal while the cell phone 1 uses the third communication method will be described.

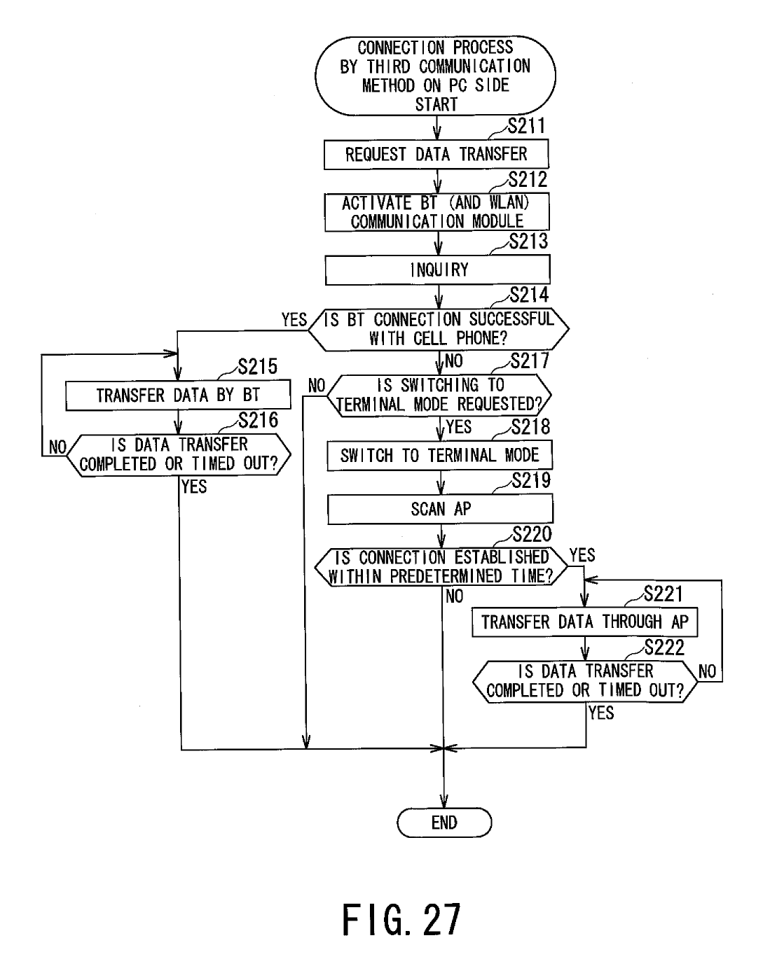

FIG. 27 is a flow chart for explaining a connection process by the third communication method in a BT mode operation executed in the PC 2 of the present embodiment.

In step S211, the BT communication module 113 receives a data transfer (data communication) request from the OS (step S181 of FIG. 24).

The BT communication module 113 is activated (Wake Up) in step S212 (step S182). In this case, the WLAN communication module 112 is also activated at the same time or after a predetermined time from the activation of BT communication module 113. In step S213, the BT communication module 113 transmits an inquiry signal (inquiry message) to other devices (step S183).

In step S214, the BT communication module 113 determines whether the connection of BT communication to the cell phone 1 has succeeded. The BT communication module 113 determines based on the presence of a connection response (step S192 of FIG. 25) transmitted from the BT communication module 13 of the cell phone 1 to the transmitted inquiry signal from the BT communication module 113 of the PC 2. Since a known method is used for the connection process between the BT communication modules 13 and 113 of the PC 2 and the cell phone 1, details will not be described.

On the other hand, if the BT communication module 113 determines that the connection to the cell phone 1 is successful, the BT communication module 113 transfers data with the BT communication module 13 of the cell phone 1 in step S215.

In step S216, the BT communication module 113 determines whether the data transfer is completed or a preset time has passed (timed out) since the last data transfer. If the BT communication module 113 determines that the data transfer is not completed or the time has not passed, the process returns to step S215, and the data transfer is continued. The process ends if the BT communication module 113 determines that the data transfer is completed or timed out.

On the other hand, if it is determined in step S214 that the connection to the BT communication module 13 of the cell phone 1 is not made yet, the WLAN communication module 112 determines whether a request for switching the operation mode to the terminal mode is received from the cell phone 1 in step S217. If the WLAN communication module 112 determines that the switch request of the terminal mode is not received, the process ends because the connection has failed.

On the other hand, if the WLAN communication module 112 determines that the terminal mode switch request is received from the cell phone 1 (step S197 of FIG. 26), the WLAN communication module 112 switches the operation mode from the BT mode to the terminal mode in step S218 (steps S198 to S200). The WLAN communication module 112 also issues a terminal mode switch notification to the WLAN communication module 12 of the cell phone 1 (step S202).

In step S219, the WLAN communication module 112 performs active scan or passive scan to scan a usable AP (step S201). In step S220, the WLAN communication module 112 determines whether the connection to the scanned AP, i.e. the cell phone 1, has succeeded within a predetermined time. At this point, the cell phone 1 is designed to operate in the AP mode (combination 2 of FIG. 11). Therefore, the WLAN communication module 112 of the PC 2 is capable of connecting with the cell phone 1 as the AP. The process ends if the WLAN communication module 112 determines that the connection to the AP has failed.

On the other hand, if the WLAN communication module 112 determines in step S220 that the connection to the AP is successful, the WLAN communication module 112 transfers data through the cell phone 1 as the connected AP in step S221. In step S222, the WLAN communication module 112 determines whether the data transfer is completed or a preset time has passed (timed out) since the last data transfer. If the WLAN communication module 112 determines that the data transfer is not completed or the time has not passed, the process returns to step S221, and the data transfer is continued. The process ends if the WLAN communication module 112 determines that the data transfer is completed or the time has passed.

In the wireless LAN connection process using the third communication method on the side of the PC 2, an example of activating the WLAN communication module 112 by the BT communication module 113 has been described. Such an operation of the PC 2 is effective in that the WLAN communication module 12 of the cell phone 1 can be activated, for example, by using the inquiry signal transmitted from the BT communication module 113 without the active scan (transmission of the probe request signal) by the WLAN communication module 112.

The signal detected by the radio signal detection circuit 23 of the cell phone 1 in the third communication method is not limited to the inquiry signal transmitted from the BT communication module 113 of the PC 2. A DM1 packet and a DH1 packet as ACL packets used in an asynchronous link may also be applied. This is because the repetition period of transmission and reception of the DM1 packet and the DH1 packet is shorter than that in other packets, and the time it takes for the detection through 10 to 80 integrations by the radio signal detection circuit 23 is short.

The cell phone 1 described above comprises the radio signal detection circuit 23 to suitably wait for a signal for requesting communication transmitted from the PC 2 as the other terminal. Therefore, the cell phone 1 does not unnecessarily activate the WLAN communication module 12 to wait for the signal transmitted from the PC 2 and does not transmit a beacon signal as an AP. Thus, the cell phone 1 is capable of reducing the power consumption during the standby for a signal from other terminals. Furthermore, a user operation for activating the WLAN communication module 12 is not necessary. Therefore, the cell phone 1 is effective to reduce cumbersome operations by the user using the network communication.

The cell phone 1 includes the three communication methods to establish wireless LAN communication connection with other terminals. Therefore, the cell phone 1 can sequentially attempt the connection by switching to other communication systems even if the cell phone 1 cannot activate in one communication system due to, for example, the influence of noise, and the success rate of connection with the PC 2 can be improved.

Furthermore, the present embodiment of connection processes explained allows the cell phone 1 and the PC 2 to automatically attempt a target communication format, in which the cell phone 1 operates in the AP mode (AP master) and the PC 2 operates in the terminal mode (AP slave). This target communication format maximizes the efficiency of the data communication of the PC 2 using the mobile communication network of the cell phone 1. Even if another communication format is established between the devices once, the connection processes automatically switches the communication format for the target one accordingly. Therefore, the cell phone 1 is capable of maintaining the efficiency of the data communication and does not require a cumbersome user operation for switching.

The PC 2 can establish the wireless LAN communication without particularly changing the firmware and the hardware of the conventional WLAN communication module even if the cell phone 1 that requests connection uses the radio signal detection circuit 23 to wait for the connection.

In the description of the example of the present embodiment, a signal for activating the WLAN communication module 12 or the BT communication module 13 is outputted to the CPU 15 in accordance with the communication methods when the radio signal detection circuit 23 detects a specific pattern of one of the radio signals. However, the radio signal detection circuit 23 may output only the fact of detecting the specific pattern of one of the radio signals to the CPU 15, and the CPU 15 may output the signal for activating the WLAN communication module 12 or the BT communication module 13 to the OS in accordance with the communication methods.

In the cell phone 1 of the present embodiment, an amplifier for amplification at carrier frequencies of the signals received by the radio signal detection circuit 23 may be arranged at an early stage of the RF signal receiving circuit 31. This is effective in that the communication distance between the cell phone 1 and the PC 2 can be extended. The cell phone 1 can intermittently stop the activation of the amplifier to realize further reduction in power consumption.

The radio signal detection circuit 23 may be configured to be able to identify the beacon signal, the probe request signal, and the inquiry signal transmitted from the PC 2. In that case, the CPU 15 reads an interruption factor from the I/F unit 50 of the radio signal detection circuit 23. The CPU 15 can identify which signal the radio signal detection circuit 23 has detected to generate the interruption signal. Accordingly, the CPU 15 can determine the communication module 12 or 13 that is activated according to the type of the signal detected by the radio signal detection circuit 23, and the cell phone 1 can further improve connection efficiency.

Specifically, if the radio signal detection circuit 23 receives a probe request signal from the PC 2 operating in the terminal mode, the radio signal detection circuit 23 can directly request the CPU 15 to activate the WLAN communication module 12 in the AP mode. If the radio signal detection circuit 23 receives a beacon signal from the PC 2 operating in the AP mode, the radio signal detection circuit 23 can directly request the CPU 15 to activate the WLAN communication module 12 in the terminal mode. If the radio signal detection circuit 23 receives a beacon signal from the PC 2 operating in the ad hoc mode, the radio signal detection circuit 23 can directly request the CPU 15 to activate the WLAN communication module 12 in the ad hoc mode. If the radio signal detection circuit 23 receives an inquiry signal from the PC 2 operating in the BT mode, the radio signal detection circuit 23 can directly request the CPU 15 to activate the BT communication module 13.

In this way, it is effective in that as the radio signal detection circuit 23 identifies the content of the signal, there is no need to find a communicable method by sequentially using the three communication methods.

In the following paragraph, a process when a synchronous process using Bluetooth communication is allocated to the detection of a BT signal in the radio signal detection circuit 23 of the cell phone 1 will be described. The synchronous process is a process of synchronizing data, for example, schedules, email, predetermined folder content, etc. between the cell phone 1 and the PC 2.

Although an example in which a synchronous processing request using Bluetooth communication is allocated for the reception of the BT signal will be described, the synchronous processing request may be allocated for the reception of the WLAN signal.

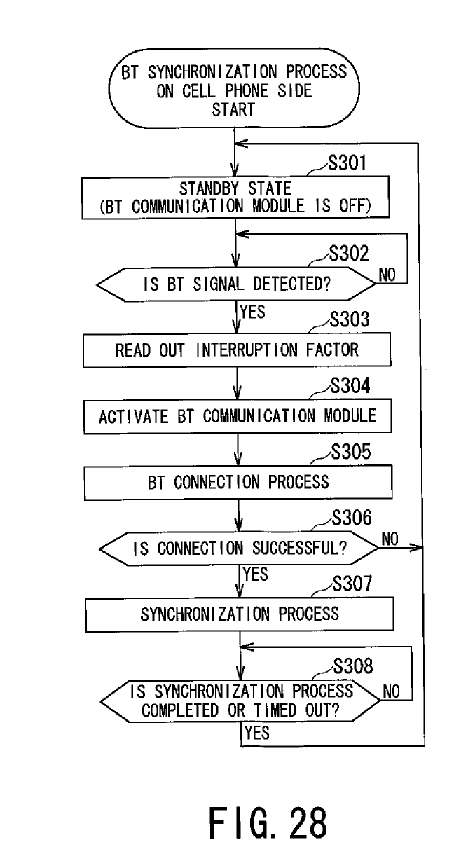

FIG. 28 is a flow chart for explaining a synchronous process by Bluetooth communication executed by the cell phone 1 of the present embodiment.

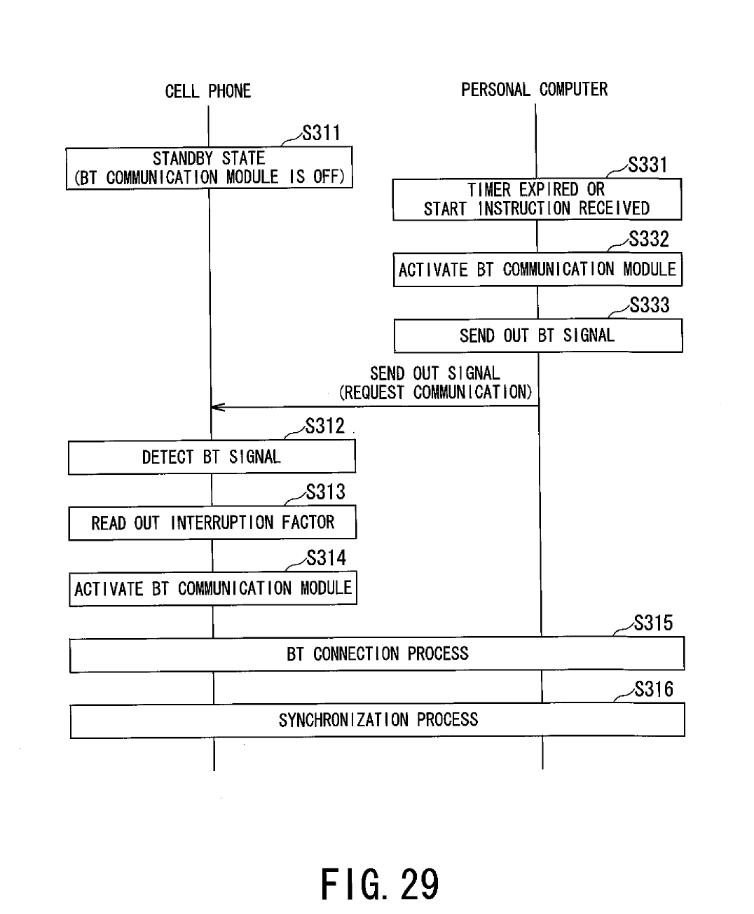

FIG. 29 is a sequence diagram showing a synchronous process between the cell phone 1 and the PC 2 by Bluetooth communication.

In step S301, the radio signal detection circuit 23 of the cell phone 1 waits for a BT signal indicating a connection request (synchronous processing request) of wireless communication using Bluetooth communication sent out from the PC 2 (step S311 of FIG. 29). At this point, the BT communication module 13 of the cell phone 1 is off.

In step S302, the cell phone 1 determines whether the BT signal is detected. Specifically, the radio signal detection circuit 23 detects a radio signal and determines whether a specific pattern outputted to the BT signal detection circuit 44 (FIG. 4) is a specific pattern of the BT signal. If the BT signal is detected, the control signal output circuit 35 outputs a control signal to the interruption signal generation circuit 14. The interruption signal generation circuit 14 outputs the interruption signal to the CPU 15. If the BT signal is not detected, the cell phone 1 waits until the detection.

If the BT signal is detected and the CPU 15 receives the interruption signal (step S312 of FIG. 29), the cell phone 1 reads an interruption factor in step S303 (step S313). In this case, the CPU 15 of the cell phone 1 identifies that the interruption signal is generated as the radio signal detection circuit 23 detects the BT signal and that the interruption process is for activation of the BT communication module 13.

In step S304, the cell phone 1 activates the BT communication module 13 (step S314). In step S305, the BT communication module 13 of the cell phone 1 executes a connection process for establishing Bluetooth communication with the PC 2 as other terminal (step S315). The connection process executed between the cell phone 1 and the PC 2 is a process generally executed in the establishment of connection of Bluetooth communication, and the details will not be described here.

In step S306, the cell phone 1 determines whether the connection process with the PC 2 is successful. If the cell phone 1 determines that the connection process is successful, the cell phone 1 executes a synchronous process with the PC 2 in step S307 (step S316).

In step S308, the cell phone 1 determines whether the synchronous process with the PC 2 is completed or timed out. The cell phone 1 continues the synchronous process until determining that the synchronous process is completed or timed out. If the cell phone 1 determines that the synchronous process is completed or timed out, the cell phone 1 returns to the standby step S301, turns off the BT communication module 13, and shifts to a standby state.

On the other hand, if the cell phone 1 determines that the connection has failed in the connection determination step S306, the cell phone 1 returns to the standby step S301 and repeats the subsequent process. If the connection has failed, the cell phone 1 shifts the BT communication module 13 to the off state and shifts to the standby state of the BT signal in the radio signal detection circuit 23 without executing the connection process with the PC 2 again. This is to prevent an increase in power consumption by unnecessarily repeating the BT connection processing step S305 if a signal that is not the BT signal is falsely detected.

A process for the PC 2 to send out the BT signal to the cell phone 1 to request the synchronous process using BT communication will be described.

The PC 2 executes the synchronous process in the background at predetermined intervals based on controlling an application or in the suitable timing based on an instruction of starting the process received from the user.

First, a synchronous process executed by controlling an application will be described.

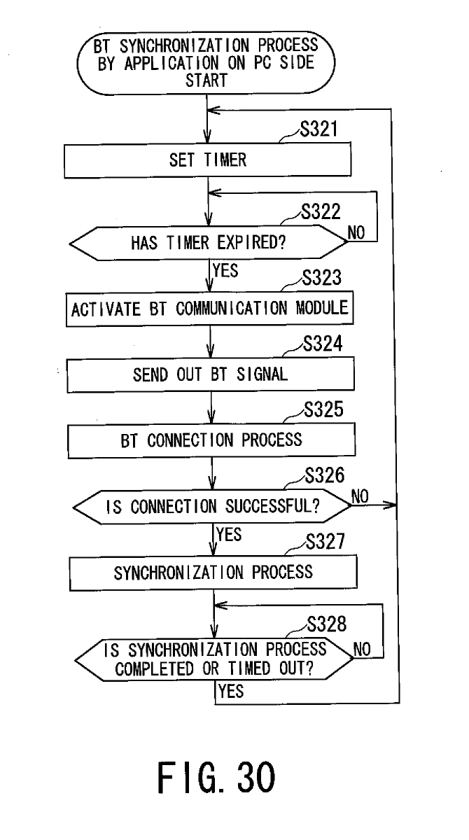

FIG. 30 is a flow, chart for explaining a synchronous process executed by controlling by an application using Bluetooth communication executed by the PC 2 of the present embodiment.

In step S321, the application (synchronization application not shown) that executes a synchronous process of the PC 2 sets the timer based on predetermined intervals. It is preferable that the intervals of the synchronous process be adjusted according to the situations, such as 60 minutes for immediately after the success of the synchronization and ten minutes in other cases. The difference of the synchronized data is small immediately after the synchronization. Therefore, the PC 2 reduces the power consumption by making the interval large.

In step S322, the synchronization application of the PC 2 determines whether the timer has expired. If it is determined that the timer has not expired, the PC 2 waits until the timer expires. On the other hand, if it is determined that the timer has expired (step S331 of FIG. 29), the PC 2 activates the BT communication module 113 in step S323 (step S332).

In step S324, the PC 2 sends out a BT signal (step S333). In step S325, the BT communication module 113 of the PC 2 executes the connection process for establishing Bluetooth communication with the cell phone 1 (step S315).

In step S326, the PC 2 determines whether the connection process with the cell phone 1 is successful. If the PC 2 determines that the connection process is successful, the PC 2 starts the synchronous process with the cell phone 1 in step S327 (step S316).

In step S328, the PC 2 determines whether the synchronous process with the cell phone 1 is completed or timed out. The PC 2 continues the synchronous process until the PC 2 determines that the synchronous process is completed or timed out. If the PC 2 determines that the synchronous process is completed or timed out, the process returns to the timer set step S321, and the following process is repeated.

A synchronous process executed when an instruction of the user for starting the process is received will be described.

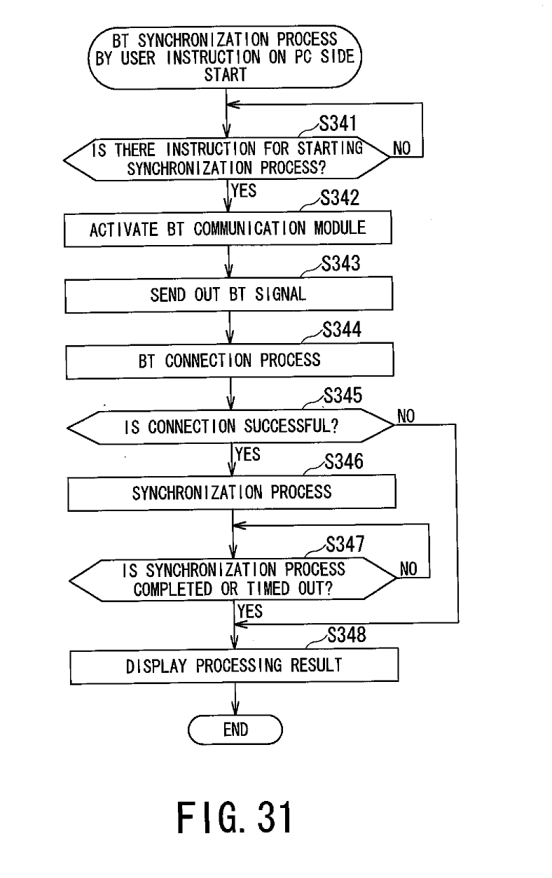

FIG. 31 is a flow chart for explaining a synchronous process executed based on a starting instruction of the user using Bluetooth communication executed by the PC 2 of the present embodiment.

In step S341, the PC 2 determines whether an instruction for starting the synchronous process with the cell phone 1 is received. The starting instruction of the synchronous process is received from, for example, the input unit 117 (FIG. 9) of the PC 2. If the PC 2 determines that the instruction for starting the synchronous process is not received, the PC 2 waits until the instruction is received.

On the other hand, if the PC 2 determines that the instruction for starting the synchronous process is received (step S331 of FIG. 29), the PC 2 activates the BT communication module 113 in step S342 (step S332). The process of the activation step S342 to a connection determination step S345 is substantially the same as the process of the activation step S323 to the connection determination step S326 in the synchronous process by Bluetooth communication of FIG. 30, and details will not be described here.

If the PC 2 determines that the connection has failed in the connection determination step S345, the process proceeds to step S348. If the connection is determined to be successful in the connection determination step S345, the PC 2 starts the synchronous process (step S316). A synchronous processing step S346 and a completion determination step S347 are substantially the same as the process of the synchronous processing step S327 and the completion determination step S328 in the synchronous process by Bluetooth communication of FIG. 30, and details will not be described here.

If the PC 2 determines that the synchronous process is completed or timed out in the completion determination step S347, the PC 2 displays the result of the synchronous process to the user in step S348 and ends the process.

This completes the description of the synchronous process executed between the cell phone 1 and the PC 2 based on the detection of the BT signal sent out from the PC 2.

In the following paragraph, a process executed by the cell phone 1 based on a UW signal and a command signal transmitted from the PC 2 will be described.

A registration process of personal UW executed by the radio signal detection circuit applications 72 and 172 of the cell phone 1 and the PC 2 will be described. The personal UW can be unique identification information commonly held between the cell phone 1 and the PC 2 to perform authentication between the two terminals. Therefore, the UW registration process described below is an example, and other methods (for example, using a MAC address of one of the terminals) may be used to determine the personal UW.

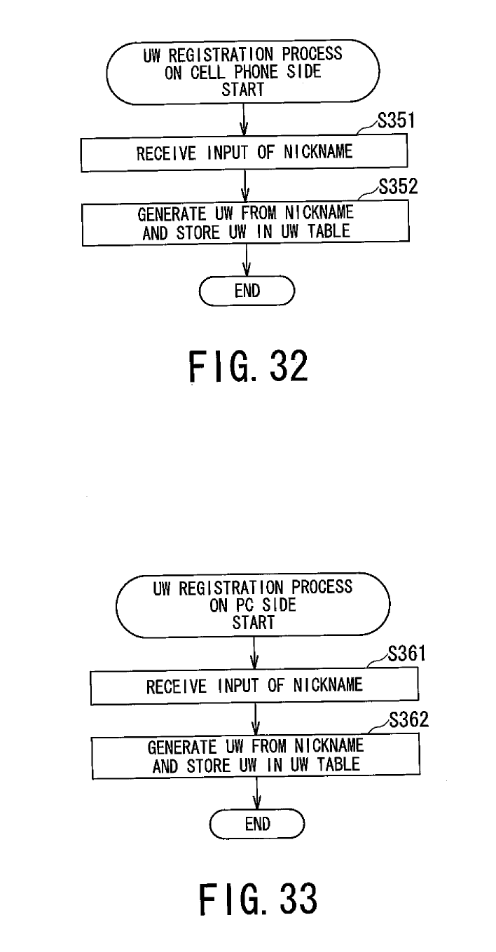

FIG. 32 is a flow chart for explaining a UW registration process executed by the cell phone 1 of the present embodiment.

In step S351, the cell phone 1 receives input of a nickname through the input unit 17, etc. The nickname is a character string optionally determined by the user. The cell phone 1 can be used the nickname not only to generate the UW, but also as ID information on applications.

In step S352, the cell phone 1 generates personal UW based on the inputted nickname and stores the personal UW in the UW table 75 of FIG. 8B. The personal UW is generated by using a hash function to calculate a hash value of the nickname.

FIG. 33 is a flow chart for explaining a UW registration process corresponding to the UW registration process of FIG. 32 executed by the PC 2 of the present embodiment.

In step S361, the PC 2 receives input of the same nickname as the nickname inputted in the cell phone 1.

In step S362, the PC 2 generates personal UW based on the inputted nickname and stores the personal UW in the UW table 175 of FIG. 8B. The personal UW is generated by using a hash function to calculate a hash value of the nickname. Therefore, since the nicknames of the cell phone 1 and the PC 2 are the same, the generated hash values also have the same values.

The nickname can be inputted (generation of personal UW) first to either terminal as long as the nicknames (UW) inputted to the cell phone 1 and the PC 2 are the same.

Another registration process of personal UW executed in the cell phone 1 and the PC 2 will be described. In the UW registration process described in FIGS. 32 and 33, the personal UW is generated based on the inputted nickname. However, a conflict occurs to the personal UW if the same nickname is inputted in another terminal for which the establishment of wireless communication is not intended. Another UW registration process described below is effective in that more specific personal UW can be generated. An example will be described, in which personal UW is generated in the PC 2, and the generated UW is copied to the cell phone 1 to register the UW to the side of the cell phone 1. However, personal UW may be generated in the cell phone 1, and the generated personal UW may be copied to the PC 2.

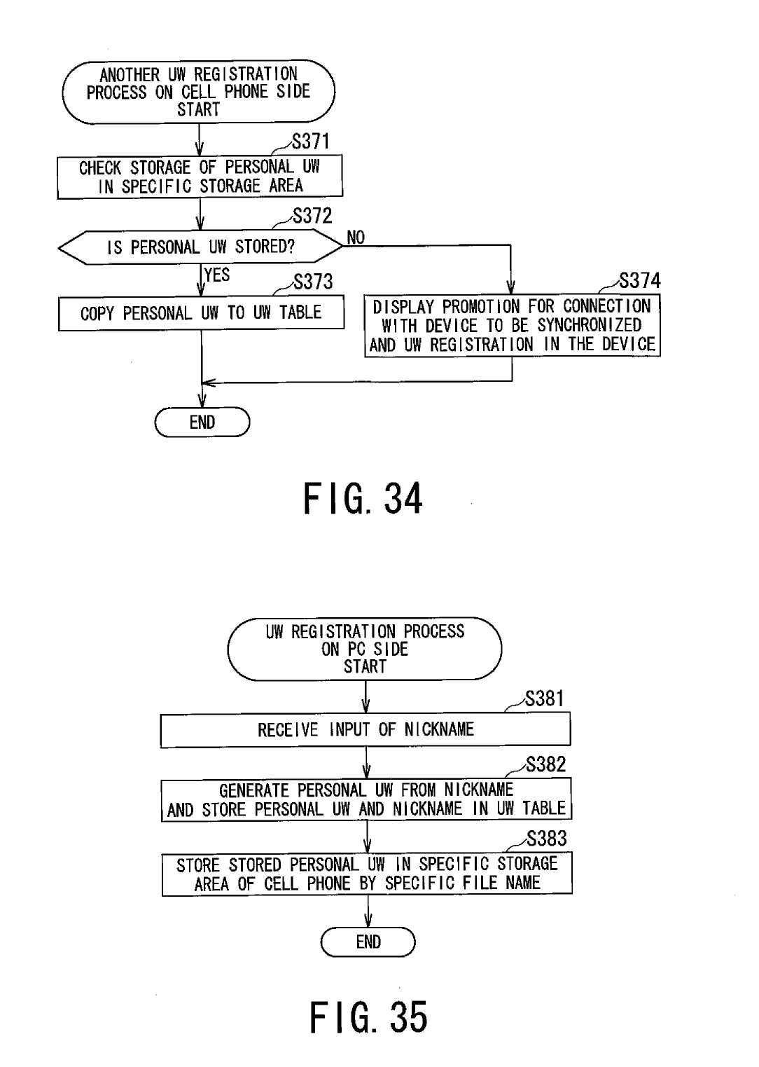

FIG. 34 is a flow chart for explaining another UW registration process executed by the cell phone 1 of the present embodiment.

In step S371, the cell phone 1 checks the storage of the personal UW in a specific storage area. The specific storage area is, for example, a area in the memory 16 designated in advance by the radio signal detection circuit application 72.

In step S372, the cell phone 1 determines whether the personal UW is stored. If the cell phone 1 determines that the personal UW is stored, the cell phone 1 copies the personal UW to the UW table 75 in step S373. On the other hand, if the cell phone 1 determines that the personal. UW is not stored, the display unit 18 displays a promotion of connection with a device to be synchronized and UW registration in the device in step S374.

FIG. 35 is a flow chart for explaining a UW registration process corresponding to the UW registration process of FIG. 34 executed in the PC 2 of the present embodiment.

In step S381, the PC 2 receives input of a nickname through the input unit 117, etc. The nickname is a character string optionally determined by the user.

In step S382, the PC 2 generates personal UW based on the inputted nickname and stores the nickname and the personal UW in the UW table 175. The personal UW is generated by using a hash function to calculate a hash value of a character string in which a random number is added to the nickname. As the hash value of the character string in which the random value is added to the nickname is set as the personal UW, the generation of hash values based on overlapping character strings is prevented, and the conflict of the personal UW is also prevented.

In step S383, the PC 2 stores the stored personal UW in a specific storage area of the cell phone 1 by a specific file name. The PC 2 stores the personal UW in the cell phone 1 by, for example, connecting through a USB (Universal Serial Bus) interface or using wireless LAN communication or Bluetooth communication to transmit the personal UW. In the display step S374 of the UW registration process of FIG. 34, the promotion for connecting to a device to be synchronized is displayed to the user. Therefore, it is preferable that the cell phone 1 and the PC 2 are connecting in the storage step S383.

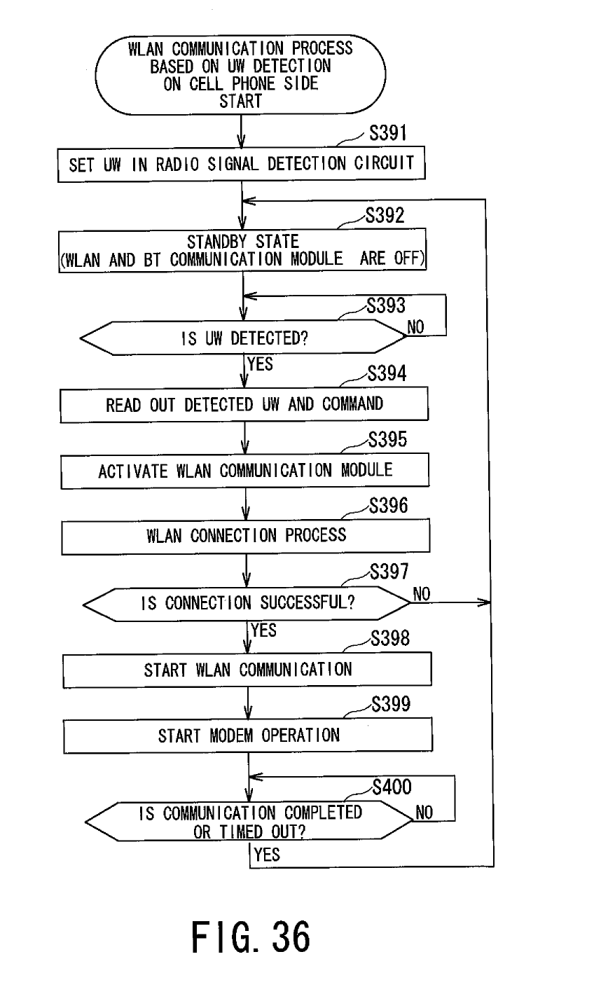

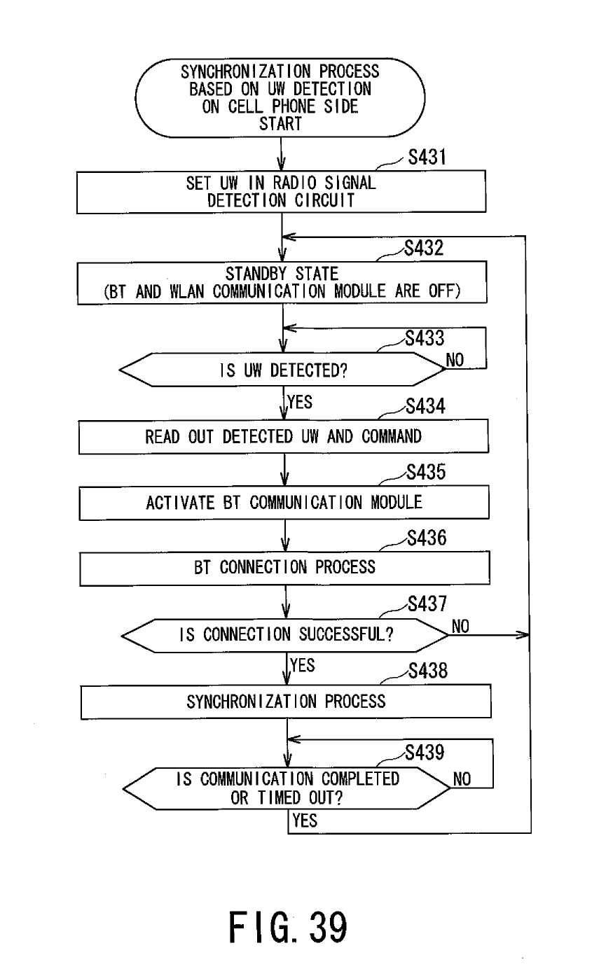

A specific process executed when a UW signal is detected in the cell phone 1 will be described. In the processes of FIGS. 36 to 38 described below, an example in which the PC 2 transmits a connection establishment request of wireless LAN communication as a command is applied. In the processes of FIGS. 39 to 41, an example in which the PC 2 transmits a synchronous processing request using Bluetooth communication as a command is applied.

FIG. 36 is a flow chart for explaining a wireless LAN communication process based on detection of a UW signal executed by the cell phone 1 of the present embodiment.

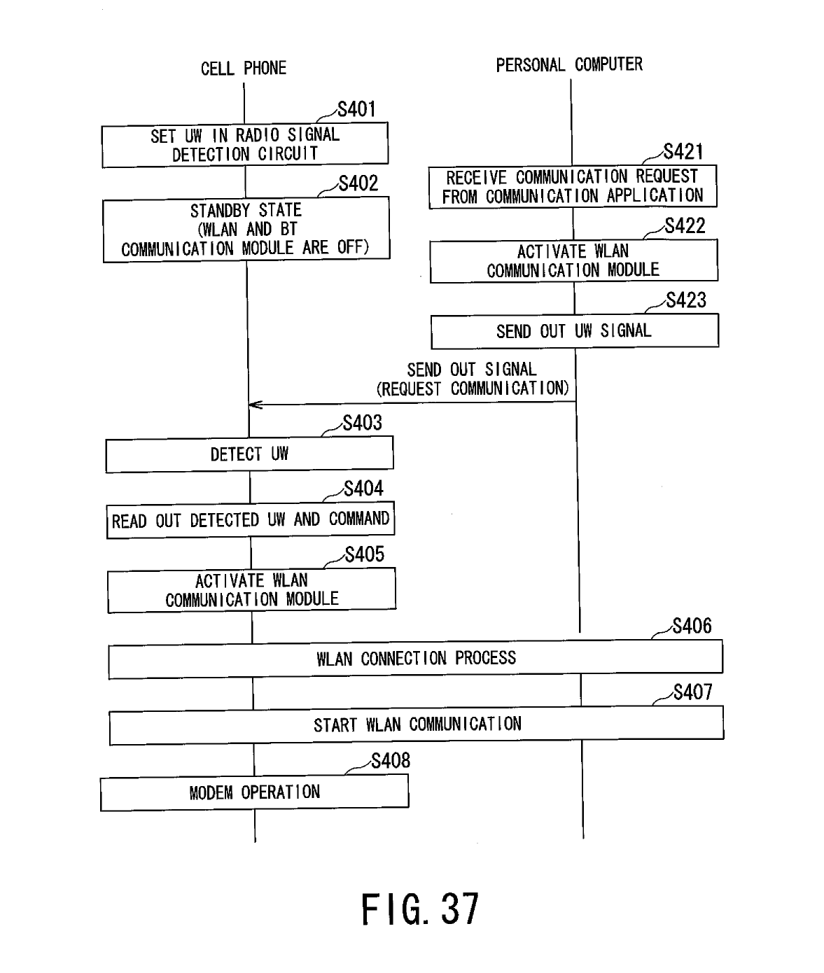

FIG. 37 is a sequence diagram showing a wireless LAN communication process based on detection of a UW signal between the cell phone 1 and the PC 2.

In step S391, the CPU 15 of the cell phone 1 sets the UW stored in the UW table 75 to the UW setting registers 51 of the radio signal detection circuit 23 (step S401 of FIG. 37). The UW is set to the UW setting registers 51 according to the number of other communication terminals in which the UW is set.

In step S392, the radio signal detection circuit 23 of the cell phone 1 waits for a UW signal sent out from the PC 2 (S402). At this point, the WLAN communication module 12 and the BT communication module 13 of the cell phone 1 are off.

In step S393, the cell phone 1 determines whether a UW is detected from the received UW signal. Specifically, the cell phone 1 compares the UW obtained from the signal modulated by the amplitude modulation UW detection circuit 41 of the radio signal detection circuit 23 and the UW set in the UW setting registers 51. Then, the cell phone 1 determines whether a UW corresponding to the UW set in the UW setting registers 51 is detected. If the obtained UW is corresponding to the UW set in the UW setting registers 51, the control signal output circuit 35 outputs a control signal to the interruption signal generation circuit 14, and the interruption signal generation circuit 14 outputs the interruption signal to the CPU 15. If the cell phone 1 determines that the UW is not detected, the cell phone 1 waits until the detection.

On the other hand, if the UW is detected and the CPU 15 receives the interruption signal (step S403), the CPU 15 reads the UW and the command through the I/F unit 50 of the radio signal detection circuit 23 in step S394 (step S404). In this case, the CPU 15 read out for example, a UW and a command indicating the establishment of wireless communication using wireless LAN communication with the PC 2.

In step S395, the cell phone 1 activates the WLAN communication module 12 (step S405). In step S396, the WLAN communication module 12 executes a connection process for establishing wireless LAN communication with the PC 2 as other communication terminal (step S406). The connection process executed between the cell phone 1 and the PC 2 is a process generally executed during the connection establishment of wireless LAN, and details will not be described here.

In step S397, the cell phone 1 determines whether the connection process with the PC 2 is successful. If the cell phone 1 determines that the connection process is successful, the cell phone 1 starts wireless LAN communication with the PC 2 in step S398 (step S407). In step S399, the cell phone 1 operates as a modem causing the PC 2 to perform communication using the mobile communication module 11 of the cell phone 1 (step S408).

In step S400, the cell phone 1 determines whether the wireless LAN communication with the PC 2 is completed or timed out. The cell phone 1 continues the modem operation until the cell phone 1 determines that the wireless LAN communication is completed or timed out. If the cell phone 1 determines that the wireless LAN communication is completed or timed out, the process returns to the standby step S392, and the cell phone 1 turns off the WLAN communication module 12 and shifts to the standby state.

On the other hand, if the cell phone 1 determines that the connection has failed in the connection determination step S397, the process returns to the standby step S392, and the subsequent process is repeated. If the connection has failed, the cell phone 1 shifts the WLAN communication module 12 to an off state without executing the connection process with the PC 2 again and shifts to a standby state of WLAN signal in the radio signal detection circuit 23. This is to prevent an increase in the amount of power consumption by unnecessarily repeating the connection processing step S396 when the radio signal detection circuit 23 falsely detects a signal that is not a WLAN signal.

A process for establishing wireless LAN communication by the PC 2 sending out a UW signal to the cell phone 1 will be described.

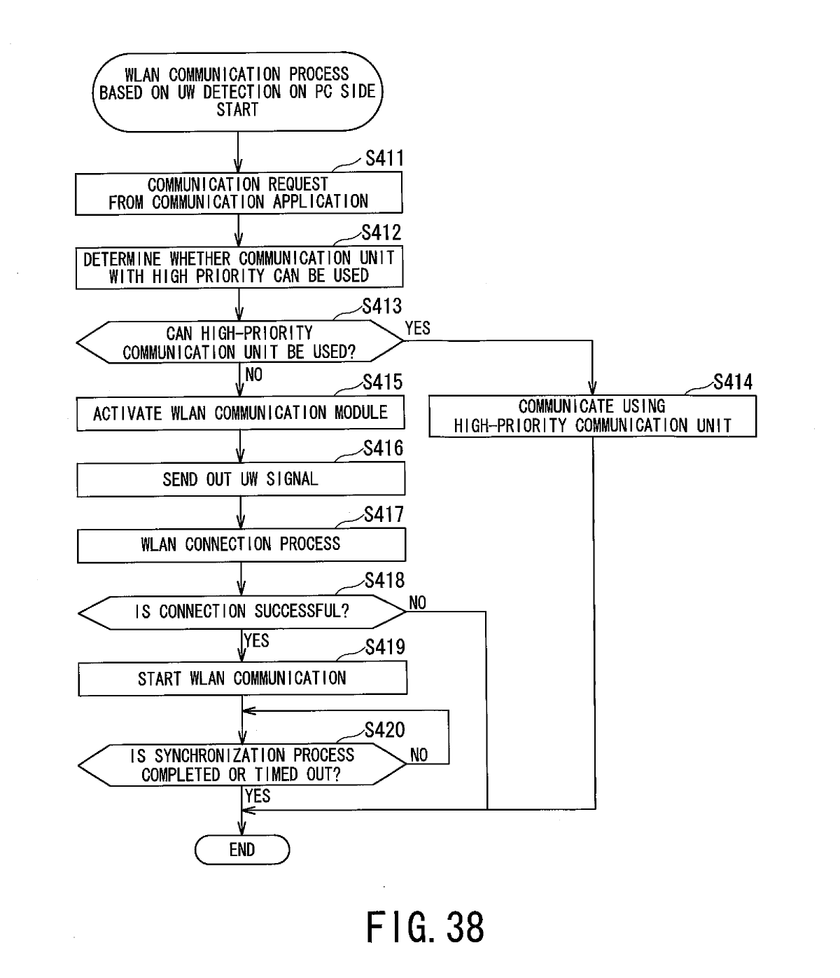

FIG. 38 is a flow chart for explaining a wireless LAN communication process based on detection of the UW signal executed by the PC 2 of the present embodiment.

In step S411, the PC 2 receives a communication request from the communication application 169 (step S421 of FIG. 37). In step S412, the PC 2 determines whether a destination with higher priority than that of the cell phone 1 among the destinations registered in advance can be used. The priorities of the destinations are information set in advance by the user or automatically provided by the PC 2.

In step S413, the PC 2 determines whether a destination with higher priority than that of the cell phone 1 can be used. If the PC 2 determines that other destination with higher priority can be used, the PC 2 communicates with the destination determined to be usable in step S414. For example, if the PC 2 determines that an access point with higher priority than that of the cell phone 1 can be used, the PC 2 responds to the communication request by using the access point.

On the other hand, if the PC 2 determines that there is no destination with higher priority than that of the cell phone 1, the PC 2 activates the WLAN communication module 112 in step S415 (step S442).

In step S416, the PC 2 sends out a UW signal (step S423). The UW signal is a signal including information related to a UW and a command set in advance with the cell phone 1 (wireless LAN communication process with the cell phone 1 here). The WLAN extension driver 180 or the BT extension driver 181 modulates the amplitude of the UW signal, and the WLAN communication module 112 or the BT communication module 113 transmits the UW signal. Either the WLAN communication module 112 or the BT communication module 113 may send out the UW signal.

In step S417, the WLAN communication module 112 of the PC 2 executes a connection process for establishing wireless LAN communication with the cell phone 1 (step S406).

In step S418, the PC 2 determines whether the connection process with the cell phone 1 is successful. If the PC 2 determines that the connection has failed in the connection determination, the process ends. On the other hand, if the PC 2 determines that the connection process is successful, the PC 2 starts wireless LAN communication with the cell phone 1 in step S419 (step S407). In this way, the PC 2 causes the cell phone 1 to operate as a modem, and a common carrier network can be used through the mobile communication module 11 of the cell phone 1.

In step S420, the PC 2 determines whether the wireless LAN communication with the cell phone 1 is completed or timed out. The PC 2 waits until determining that the wireless LAN communication is completed or timed out. The process ends if the PC 2 determines that the wireless LAN communication is finished or timed out.

The PC 2 may send out the WLAN signal for a plurality of times to prevent false detection or missed detection of the WLAN signal in the cell phone 1 in the signal sending step S416.

FIG. 39 is a flow chart for explaining a synchronous process by Bluetooth communication based on detection of a UW signal executed by the cell phone 1 of the present embodiment.

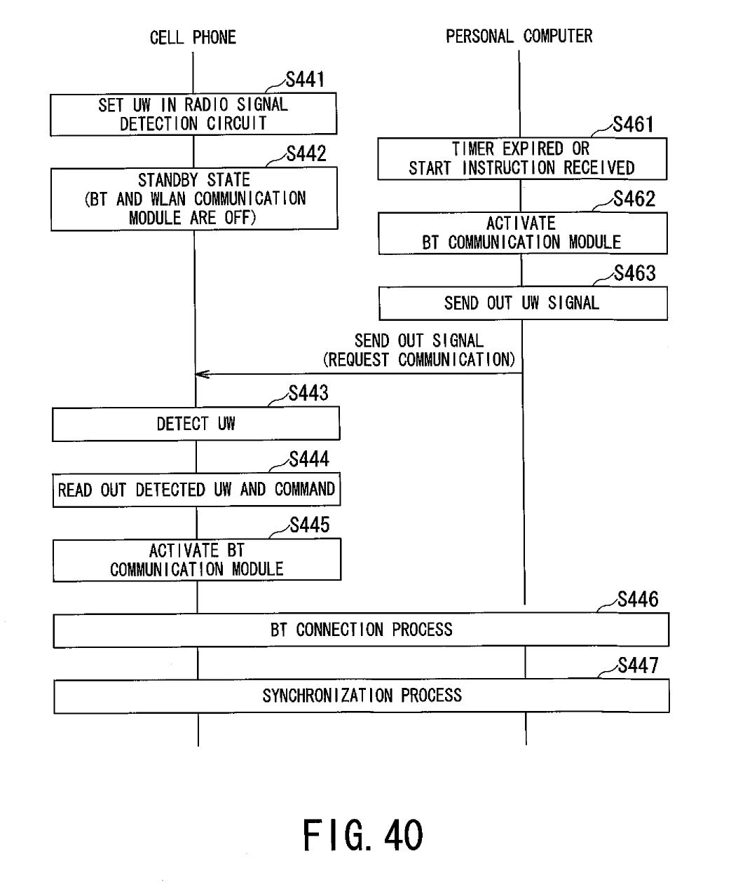

FIG. 40 is a sequence diagram showing a synchronous process between the cell phone 1 and the PC 2 using Bluetooth communication.

In step S431, the CPU 15 of the cell phone 1 sets the UW stored in the UW table 75 to the UW setting registers 51 of the radio signal detection circuit 23 (step S441 of FIG. 40).

In step S432, the radio signal detection circuit 23 of the cell phone 1 waits for a UW signal sent out from the PC 2 (step S442). At this point, the WLAN communication module 12 and the BT communication module 13 of the cell phone 1 are off.

In step S433, the cell phone 1 determines whether UW is detected from the UW signal. If the UW is detected and the CPU 15 receives an interruption signal (step S443), the cell phone 1 reads the UW and the command through the I/F unit 50 of the radio signal detection circuit 23 in step S434 (step S444).

The process of an activation step S435 to a completion determination step S439 (an activation step S445 to a synchronization step S447) is substantially the same as the process of the activation step S304 to the completion determination step S308 of FIG. 28 (the activation step S314 to the synchronization step S316 of FIG. 29).

A process by the PC 2 establishing a synchronous process using BT communication by sending out a UW signal to the cell phone 1 will be described.

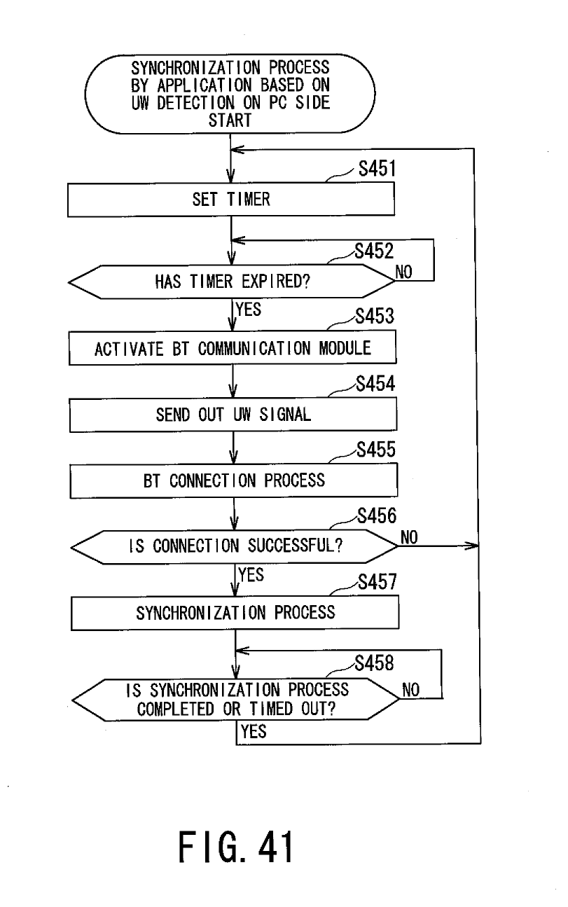

FIG. 41 is a flow chart for explaining a synchronous process that uses Bluetooth communication based on detection of a UW signal executed by the PC 2 and that is executed by an application according to the present embodiment.

A timer set step S451 to an activation step S453 (a timer expiration step S461 and an activation step S462 of FIG. 40) are substantially the same processes as the timer set step S321 to the activation step S323 of FIG. 30 (the timer expiration processing step S331 and the activation step S332 of FIG. 29).

In step S454, the PC 2 sends out a UW signal (step S463 of FIG. 40). The UW signal includes information related to a UW and a command (in this case, a synchronous process using Bluetooth communication with the cell phone 1). The WLAN extension driver 180 or the BT extension driver 181 modulates the amplitude of the UW signal, and the WLAN communication module 112 or the BT communication module 113 transmits the UW signal.

The process of a connection processing step S455 to a completion determination step S458 (a connection processing step S446 and a synchronous processing step S447) is substantially the same as the process of the connection processing step S325 to the completion determination step S328 of FIG. 30 (the connection processing step S315 and the communication starting step S316 of FIG. 29), and details will not be described.

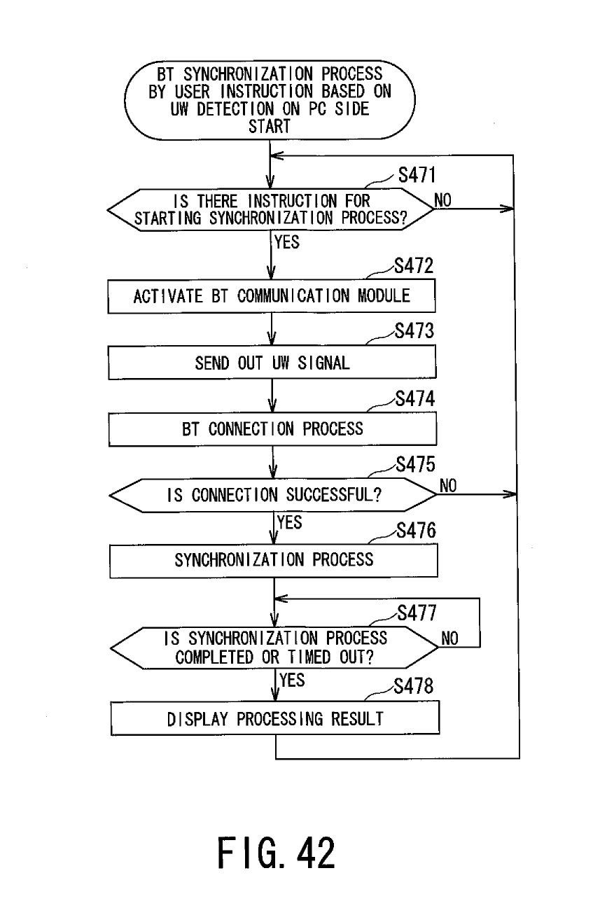

FIG. 42 is a flow chart for explaining a synchronous process that is a process using Bluetooth communication based on detection of a UW signal executed by PC 2 and that is executed based on a starting instruction of the user according to the present embodiment.

An instruction determination step S471 and an activation step S472 (an instruction receiving step S461 and an activation step S462 of FIG. 40) are substantially the same processes as the instruction determination step S341 and the activation step S342 of FIG. 31 (the instruction receiving step S331 and the activation step S332 of FIG. 29).

In step S473, the PC 2 sends out a UW signal (step S463 of FIG. 40). The UW signal sending step S473 is substantially the same process as the UW signal sending step S343 of FIG. 31 (the UW signal sending step S333 of FIG. 29).

A connection processing step S474 to a display step S478 (a connection processing step S446 and a synchronous processing step S447 of FIG. 40) are substantially the same processes as the connection processing step S344 to the display step S348 of FIG. 31 (the connection processing step S315 and the communication starting step S316 of FIG. 29).

This completes the description of the process of establishing the wireless communication between the cell phone 1 and the PC 2 based on the detection of the UW signal sent out from the PC 2.

If a command other than for the wireless LAN communication process and the synchronous process using Bluetooth communication is transmitted, a process executed after the CPU 15 of the cell phone 1 reads the command by the radio signal detection circuit 23 is different. For example, the process after the WLAN communication module activation step S395 of FIG. 36 changes to a process corresponding to the command. Specifically, the CPU 15 refers to the UW table 75 shown in FIG. 8A and activates a predetermined application program associated with the combination of the stored UW and command.

A process executed to register the UW and the command allocated to the application will be described. The application in the present process is an application installed in advance in the cell phone 1 or an application added by downloading, etc. The application can be activated and operated by other terminals using wireless communication. The UW and the command are allocated to the application in advance. As described, the UW allocated to the application may be the “personal UW” shown in FIG. 8B.

Although not described in detail, the UW for activating and operating the application is similarly stored in the UW table in other terminals (PC 2 in the present embodiment).

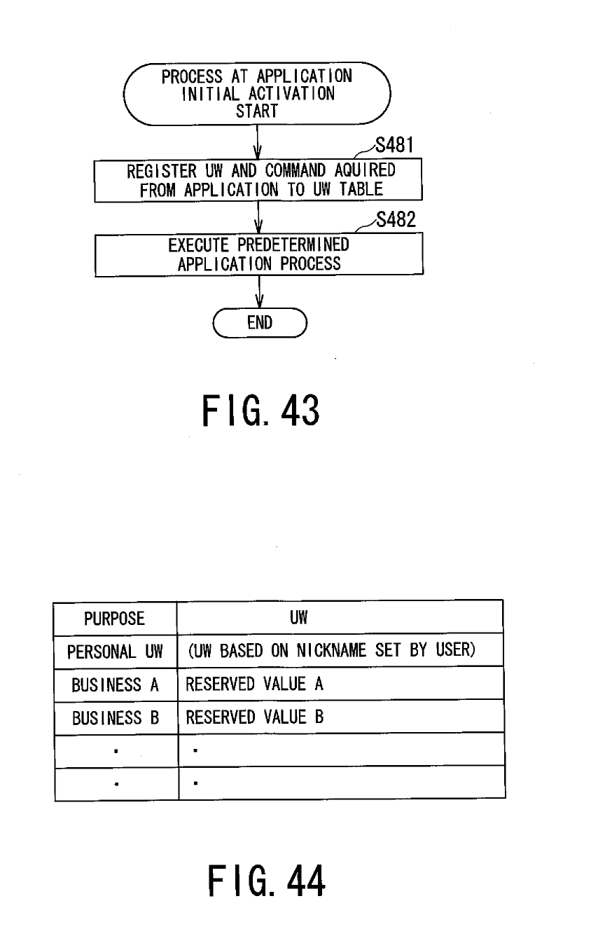

FIG. 43 is a diagram for explaining a UW registration process executed at application initial activation in the cell phone 1 of the present embodiment.

In step S481, the CPU 15 (or radio signal detection, circuit 23) of the cell phone 1 registers the UW, the command and the activation application information acquired from the application program in the UW table 75. The UW and the command are held in advance by the application program. If the “personal UW” is designated to the UW allocated to the application program, the CPU 15 allocates the UW to the application program in FIG. 8A as the same UW value as in FIG. 8B, which is stored in step S352 in the UW registration process of FIG. 32 or in the step S373 in another UW registration process of FIG. 34.

In step S482, the cell phone 1 executes a predetermined process after the activation of the application.

The allocation of the UW and the commands to various applications allows easy execution, with low power consumption, of an address exchange process with other terminals, a distribution process of advertisement content from terminals set by companies, etc. using a local communication process. More specifically, modules with high power consumption, such as WLAN and BT communication modules, can be set to a standby state, and an operation by the user to activate the communication modules can be skipped.

An example of another method of utilizing the UW is to allocate the UW to businesses to be used in business purposes.

FIG. 44 is a diagram showing a table in which UW is allocated to each business.

For example, the cell phone 1 is registered with a UW of a business, from which the user desires to receive services. The cell phone 1 can also be registered with the UW in advance on the UW table 75 of the cell phone 1. For example, the business installs a terminal for providing content at a predetermined location, such as a station. The user approaches the terminal to receive a UW signal from the terminal of the business. The cell phone 1 can activate a predetermined application program stored in the UW table and receive content from the terminal of the business.

In the present embodiment, the WLAN extension driver 180 and the BT extension driver 181 capable of amplitude modulation processing are arranged on the PC 2, and the BT communication module 113 and the WLAN communication module 112 have transmission functions of UW signal. However, the arrangement is not limited to this, and a dedicated. UW transmitter may be arranged on the PC 2.

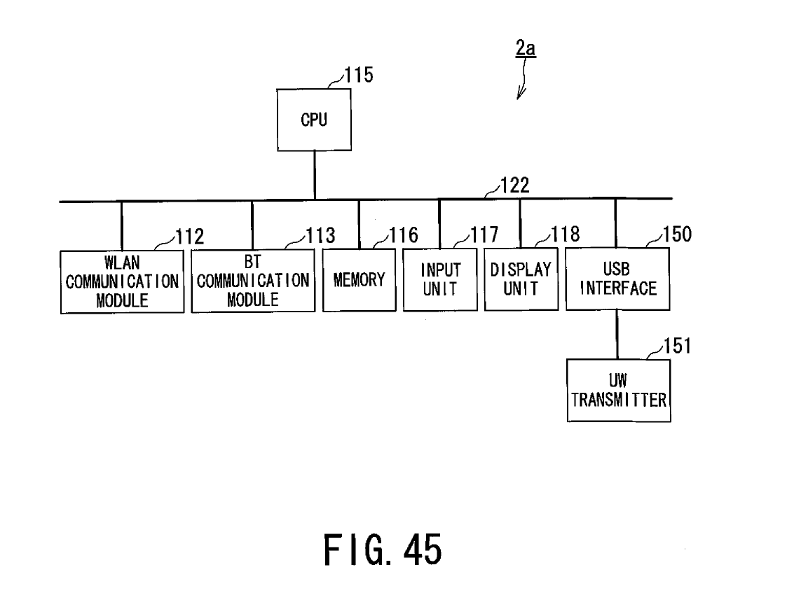

FIG. 45 is a hard system block diagram as a modified example of the PC 2 of the present embodiment.

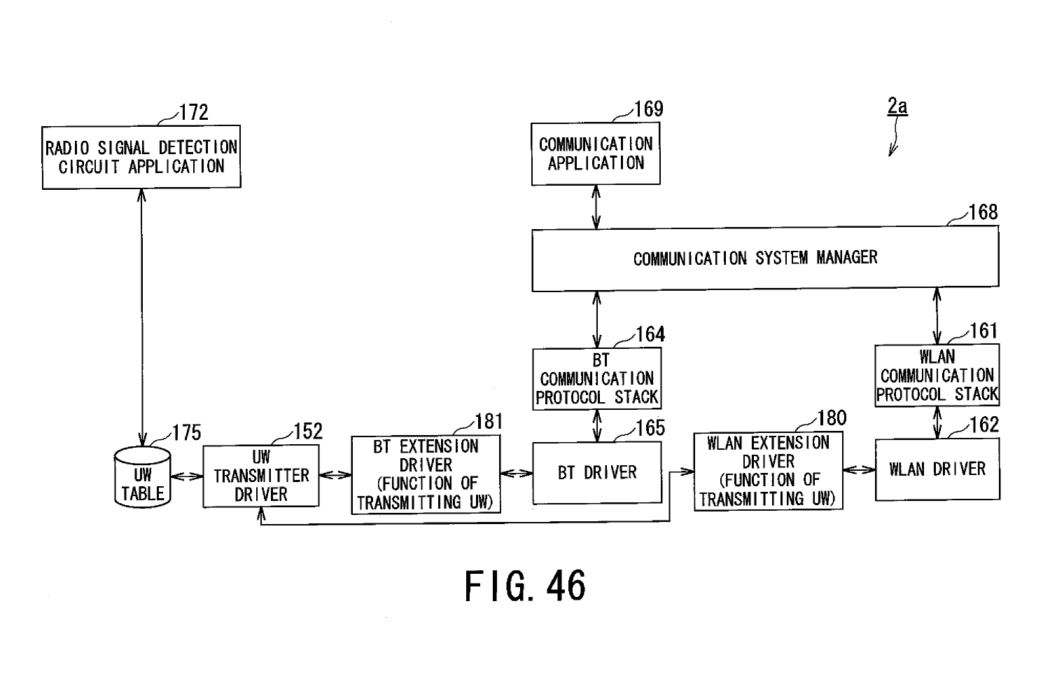

FIG. 46 is a software system block diagram as a modified example of the PC 2 of the present embodiment.

The parts common to FIGS. 9 and 10 are designated with the same reference numerals, and details will not be described.

A PC 2a of FIG. 45 is different from the PC 2 of FIG. 9 in that a unique word (UW) transmitter 151 is connected through a USB interface 150.

The PC 2a of FIG. 46 is different from the PC 2 of FIG. 10 in that a UW transmitter driver 152 is arranged.

The UW transmitter 151 is a dedicated transmitter for modulating the amplitude of the UW and the command before sending out. The UW transmitter driver 152 modulates the amplitude of the UW and the command stored in the UW table 175 and causes the UW transmitter 151 to transmit the UW and the command as a UW signal.

In this way, the UW transmitter 151 can be connected through the USB interface 150, etc. Therefore, even a communication terminal without a UW transmission function can realize various processes described in the present embodiment.

According to the cell phone 1 and the PC 2 that requests the cell phone 1 for connection described above, power consumption when the cell phone 1 waits for a connection establishment request of local communication between terminals can be suitably reduced. Furthermore, the process executed by the cell phone 1 according to the combination of the UW and the command can be controlled, and an operation for establishing wireless communication as well, as an operation for activating applications to be executed can be skipped in the cell phone 1 and the PC 2. Therefore, the operability can be improved for the user.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

An example of processing executed in chronological order in accordance with the described order is illustrated in the series of processes described in the embodiment of the present invention. However, the processes may not be executed in chronological order, and the embodiment of the present invention also includes processes executed in parallel or individually.

What is claimed is:

1. A communication device comprising:
a wireless communication unit;
a radio signal detection unit; and
a control unit, wherein
the wireless communication unit performs a wireless communication process with other terminal that transmits radio signals for requesting the wireless communication between terminals,
the radio signal detection unit waits for the radio signals with lower operating power than operating power when the wireless communication unit waits for the radio signals, and
the control unit activates the wireless communication unit to cause the wireless communication unit to perform a connection process of the wireless communication if the radio signal detection unit detects the radio signals.

2. The communication device according to claim 1, further comprising
a network communication unit that communicates with a predetermined communication network, wherein
the control unit controls the network communication unit to be a relay station of the other terminal to cause the other terminal to perform data communication if the connection process with the other terminal is successful.

3. The communication device according to claim 1, wherein
the control unit performs a synchronous process with the other terminal if the connection process with the other terminal is successful.

4. The communication device according to claim 1, wherein
the control unit turns off the power of the wireless communication unit if the wireless communication unit fails the connection process.

5. The communication device according to claim 1, the radio signal detection unit comprising:
an RF signal receiving circuit;
a rectifier circuit;
a baseband signal amplifier circuit;
a signal identification circuit; and
a control signal output circuit, wherein
the RF signal receiving circuit receives the radio signals and outputs RF signals,
the rectifier circuit rectifies and detects the RF signals and acquires demodulation signals,
the baseband signal amplifier circuit amplifies the demodulation signals and outputs predetermined signals,
the signal identification circuit identifies whether the radio signals are detected by comparing a specific pattern of the predetermined signals and a specific pattern of a radio signals to be received, the specific pattern being judged based on a period between successive signals and a level of each signal detected along the time axis, and
the control signal output circuit outputs a control signal to the control unit based on an identification result outputted by the signal identification circuit.

6. The communication device according to claim 1, wherein
the wireless communication unit is a wireless LAN communication module that performs wireless LAN communication.

7. The communication device according to claim 6, wherein
the control unit activates the wireless communication unit in an AP mode for operating as an access point, and
the wireless communication unit performs the connection process of the wireless communication by transmitting beacon signals to the other terminal.

8. The communication device according to claim 7, wherein
if the wireless communication unit fails the connection process, the control unit switches the wireless communication unit to a terminal mode for scanning the beacon signals, and
the wireless communication unit performs the connection process of the wireless communication by scanning the other terminal.

9. The communication device according to claim 8, wherein
if the connection process by the wireless communication unit is successful, the control unit switches the wireless communication unit to the AP mode, and
the wireless communication performs the connection process of the wireless communication by transmitting beacon signals to the other terminal.

10. The communication device according to claim 9, wherein
the wireless communication unit transmitting a signal for switching the other terminal to the terminal mode, and performs the connection process of the wireless communication.

11. The communication device according to claim 6, wherein
the control unit activates the wireless communication unit to communicate in an ad hoc mode, and
the wireless communication unit performs the connection process of the wireless communication by scanning the other terminal.

12. The communication device according to claim 11, wherein
if the connection process by the wireless communication unit is successful, the control unit switches the wireless communication unit to an AP mode for operating as an access point, and
the wireless communication unit performs the connection process of the wireless communication by transmitting beacon signals to the other terminal.

13. The communication device according to claim 1, wherein
the wireless communication unit is a Bluetooth communication module that performs Bluetooth communication.

14. The communication device according to claim 13, the wireless communication unit further comprising
a wireless LAN communication module that performs wireless LAN communication, wherein
if the radio signals detection unit receives a signal transmitted from the other terminal in the Bluetooth communication, the control unit activates the wireless LAN communication module in an AP mode for operating as an access point, and
the wireless LAN module performs the connection process of the wireless communication by transmitting beacon signals to a wireless LAN communication module of the other terminal.

15. The communication terminal according to claim 1, wherein
the radio signals is identification information used to identify the other terminal, the radio signals including unique word information set with the other terminal.

16. The communication terminal according to claim 15, further comprising
a unique word storage unit that stores application information associated with the unique word information and command information indicating a process performed after activation, wherein
the radio signals further includes command information, and
the control unit determines an activating application based on the application information stored the unique word storage and the unique word information and the command information including the radio signals.

17. A communication device comprising:
a wireless LAN communication unit configured to perform a wireless LAN communication process with other terminal that transmits WLAN signals for requesting the wireless LAN communication process between terminals;
a Bluetooth communication unit configured to perform a Bluetooth communication process with other terminal for transmitting BT signals for requesting the Bluetooth communication process between terminals;
a network communication unit configured to communicate with a predetermined communication network;
a radio signal detection unit configured to wait for the WLAN signals and the BT signals with lower operating power than the operating power when the wireless LAN communication unit and the Bluetooth communication unit wait for the WLAN signals and the BT signals; and
the control unit configured to activate the wireless LAN communication unit or the Bluetooth communication unit to cause the wireless LAN communication unit or the Bluetooth communication unit to perform a connection process with the other terminal if the radio signal detection unit detects the WLAN signals or the BT signals and causes the other terminal to connect to the communication network to perform data communication if the connection process is successful, wherein
the control unit after establishing connection of the wireless communication by using three communication methods in a predetermined order:
the first communication method being configured to activate the wireless LAN communication unit in an AP mode for operating as an access point to cause the wireless LAN communication unit to transmit beacon signals to the other terminal to perform the connection process of the wireless communication;
the second communication method being configured to activate the wireless LAN communication unit to communicate in an ad hoc mode to cause the wireless LAN communication unit to scan the other terminal to perform the connection process of the wireless communication; and
the third communication method being configured to activate the Bluetooth communication unit to cause the Bluetooth communication unit to perform the connection process of the wireless communication.

18. The communication device according to claim 17, wherein
if the connection process is successful, the control unit switches an operation mode of the communication device to the AP mode and switches an operation mode of the other terminal to a terminal mode for scanning the beacon signals.

19. The communication device according to claim 17, wherein
the control unit establishes connection with the other terminal by executing the first communication method, the second communication method, and the third communication method, in that order.

20. A wireless communication connection method comprising the step of:
preparing a wireless communication unit to configured to perform a wireless communication process with other terminal that transmits the radio signals for requesting the wireless communication;
preparing a radio signal detecting unit configured to wait for the radio signals with lower operating power than operating power when the wireless communication unit waits for the radio signals;
waiting the radio signals by the radio signal detection unit;
activating the wireless communication unit if the radio signal detection unit detects the radio signals; and
performing the wireless communication process after activation of the wireless communication unit.
